(19) United States
(12) Patent Application Publication
(10) Pub. No.: US 2012/0057845 A1
(43) Pub. Date: Mar. 8, 2012

(54) Information processing apparatus, information processing method, and program

(75) Inventors: Michimasa Obana, Tokyo (JP); Hiroshige Okamoto, Kanagawa (JP); Masashi Ota, Tokyo (JP)

(73) Assignee: Sony Corporation, Tokyo (JP)

(21) Appl. No.: 12/932,756

(22) Filed: Mar. 4, 2011

(30) Foreign Application Priority Data
Mar. 24, 2010 (JP) P2010-068263

(51) Int. Cl. H04N 9/80

(52) U.S. Cl. 386/241; 386/E05.003

(57) ABSTRACT

An information processing apparatus includes: a selection section to select frames of thumbnail targets, as thumbnail frames, from a moving image including frames continuous in terms of time; a division section to divide the selected thumbnail frames in units of pages each including thumbnail frames continuous in terms of time; a reproduction speed input section to receive a designation of a reproduction speed of the moving image; a reproduction processing section to reproduce the moving image at the designated reproduction speed; and a thumbnail display processing section to display thumbnail images in the units of pages including a latest thumbnail image with a thumbnail image of a thumbnail frame closest to a time of day of the reproduced moving image as the latest thumbnail image, and display the thumbnail images that include at least the latest thumbnail image and are continuous in a time sequence in a distinguishable form.

### CROSS-REFERENCE TO RELATED APPLICATION

The present application claims priority from Japanese Patent Application No. JP 2010-068263 filed in the Japanese Patent Office on Mar. 24, 2010, the entire content of which is incorporated herein by reference.

### BACKGROUND OF THE INVENTION

1. Field of the Invention

The present invention relates to an information processing apparatus, an information processing method, and a program that are capable of displaying thumbnail images of moving image content to enable a scene search to be made by a user.

2. Description of the Related Art

In information processing apparatuses such as personal computers and television apparatuses having a video recording function, part of frames of recorded video content are displayed in thumbnails so as to help a user perform a scene search of the recorded video content. In this case, in order that the user can speedily retrieve a target scene in a visual form, there is also known a method of displaying a list of frames formed into thumbnails in a time sequence at constant time intervals of video content (for example, in ten seconds, ten minutes). In addition, there is also known a method of detecting frames assumed to be the highlight, such as a frame showing a face of a(n) (important) subject and a frame of a switching position of a scene, and generating thumbnail images of those frames (see, for example, Japanese Patent Application Laid-open No. 2006-086612 (paragraphs [0121] to [0124]); hereinafter, referred to as Patent Document 1).

Further, Patent Document 1 describes that, by a user selecting any thumbnail on a film roll as a time sequence of thumbnail images, reproduction processing is activated from that position of a moving image. Here, it is assumed that the film roll is constituted of a row as a time sequence of a plurality of thumbnail images, which includes a thumbnail image corresponding to a time of day of the moving image, and advances along with the time of day of the moving image being reproduced.

### SUMMARY OF THE INVENTION

However, since the film roll as a time sequence of thumbnail images advances along with the time of day of the moving image being reproduced in Patent Document 1, there arises a problem of visibility of thumbnail images for the user during reproduction of the moving image. Particularly, assuming the case of high-speed reproduction of a moving image at 5× speed or 10× speed, a processing load is increased as a matter of course due to repeated high-speed drawing of the film roll, and there is a fear that the visibility of each thumbnail image is significantly lowered due to the high-speed advance of the film roll.

In view of the circumstances as described above, it is desirable to provide an information processing apparatus, an information processing method, and a program that are capable of excellently performing a scene search using thumbnail images.

According to an embodiment of the present invention, there is provided an information processing apparatus including a selection section, a division section, a reproduction speed input section, a reproduction processing section, and a thumbnail display processing section. The selection section selects a plurality of frames of thumbnail targets, as thumbnail frames, from a moving image including a plurality of frames continuous in terms of time. The division section divides the selected thumbnail frames in units of pages each including a plurality of thumbnail frames continuous in terms of time. The reproduction speed input section receives a designation of a reproduction speed of the moving image. The reproduction processing section reproduces the moving image at the designated reproduction speed. The thumbnail display processing section displays a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and display one or more of the thumbnail images that include at least the latest thumbnail image and are continuous in a time sequence, as moving-image-synchronized thumbnail images, in a form distinguishable from a different thumbnail image being displayed.

In the embodiment of the present invention, the thumbnail display processing section displays a plurality of thumbnail images in units of pages including a latest thumbnail image in a matrix arrangement, the latest thumbnail image corresponding to a thumbnail frame positioned closest to a time of day of the reproduced moving image, and displays one or more of the thumbnail images that include at least the latest thumbnail image and are continuous in a time sequence, as moving-image-synchronized thumbnail images, in a form distinguishable from a different thumbnail image being displayed. Accordingly, a user who performs a scene search can immediately identify one or more moving-image-synchronized thumbnail images while the arrangement relationship between the thumbnail images is fixed in a matrix. Consequently, it is possible to perform an excellent scene search while referring to a moving image and thumbnail images.

When one of the plurality of thumbnail images displayed in the matrix arrangement is selected by a user, the reproduction processing section may cause the time of day of the moving image being reproduced to jump to a time of day of a thumbnail frame corresponding to the selected thumbnail image.

Accordingly, for example, a user can check the details of a scene from the moving image at a time of day of an interesting thumbnail image, with the result that the scene search can be performed efficiently.

The information processing apparatus according to the embodiment of the present invention may further include an importance degree calculation section configured to calculate a degree of importance for each thumbnail frame, and the thumbnail display processing section may reflect the calculated degree of importance for each thumbnail frame on a display form of the thumbnail images.

Accordingly, a user who performs a scene search can immediately recognize a thumbnail image with a higher degree of importance in the thumbnail images, with the result that the scene search can be performed efficiently.

The thumbnail display processing section may change the number of thumbnail images imparted with a display form distinguishable as the moving-image-synchronized thumbnail images, in accordance with the reproduction speed of the moving image that is received by the reproduction speed input section.

For example, in a case where the reproduction speed of the moving image is slow, the number of moving-image-synchronized thumbnail images is also simultaneously reduced, with the result that the accuracy desired by a user in a scene search can be reflected on both the reproduction speed of the moving image and a display count of the thumbnail images on one screen.

The thumbnail display processing section may preferentially thin out an arrangement having a smaller sum of the degrees of importance of the thumbnail frames in at least one of an arrangement in units of rows of the matrix and an arrangement in units of columns of the matrix.

Accordingly, a large fluctuation of a positional relationship between thumbnail images in the matrix can be avoided before and after the change of the reproduction speed, which allows a user to easily find the same thumbnail image under situations in which the reproduction speed of a moving image differs, with the result that the operability can be improved.

The reproduction processing section may control a reproduction speed of the moving image based on the reproduction speed of the moving image that is received by the reproduction speed input section so that thumbnail images imparted with a display form distinguishable as the moving-image-synchronized thumbnail images are switched at a constant speed.

Accordingly, irrespective of the number of thumbnail frames per unit time, the thumbnail images imparted with a display form distinguishable as the moving-image-synchronized thumbnail images can be switched at a constant speed, with the result that a scene search can be performed by average weight on the thumbnail images.

According to another embodiment of the present invention, there is provided an information processing method including: selecting, by a selection section, a plurality of frames of thumbnail targets, as thumbnail frames, from a moving image including a plurality of frames continuous in terms of time; dividing, by a division section, the selected thumbnail frames in units of pages each including a plurality of thumbnail frames continuous in terms of time; receiving, by a reproduction speed input section, a designation of a reproduction speed of the moving image; reproducing, by a reproduction processing section, the moving image at the designated reproduction speed; and displaying, by a thumbnail display processing section, a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and displaying one or more of the thumbnail images that include at least the latest thumbnail image and are continuous in a time sequence, as moving-image-synchronized thumbnail images, in a form distinguishable from a different thumbnail image being displayed.

According to another embodiment of the present invention, there is provided a program causing a computer to function as: a selection section configured to select a plurality of frames of thumbnail targets, as thumbnail frames, from a moving image including a plurality of frames continuous in terms of time; a division section configured to divide the selected thumbnail frames in units of pages each including a plurality of thumbnail frames continuous in terms of time; a reproduction speed input section configured to receive a designation of a reproduction speed of the moving image; a reproduction processing section configured to reproduce the moving image at the designated reproduction speed; and a thumbnail display processing section configured to display a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and display one or more of the thumbnail images that include at least the latest thumbnail image and are continuous in a time sequence, as moving-image-synchronized thumbnail images, in a form distinguishable from a different thumbnail image being displayed.

According to the embodiments of the present invention, it is possible to excellently perform a scene search using thumbnail images.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing the structure of an information processing apparatus according to a first embodiment of the present invention;

FIG. 2 is a flowchart on detection of a feature frame of moving image content by the information processing apparatus shown in FIG. 1;

FIG. 3 is a flowchart on thumbnail display processing by the information processing apparatus shown in FIG. 1;

FIG. 4 is a timing chart of the thumbnail display processing by the information processing apparatus shown in FIG. 1;

FIG. 5 is a diagram showing a first calculation example of the degree of importance of a feature frame by the information processing apparatus shown in FIG. 1;

FIG. 6 is a diagram showing a second calculation example of the degree of importance of a feature frame by the information processing apparatus shown in FIG. 1;

FIG. 7 is a diagram showing a third calculation example of the degree of importance of a feature frame by the information processing apparatus shown in FIG. 1;

FIG. 8 is a diagram showing a method of arranging thumbnail images in a page unit by the information processing apparatus shown in FIG. 1;

FIG. 9 is a flowchart showing a calculation procedure of a thumbnail display count by a thumbnail display count determination section of the information processing apparatus shown in FIG. 1;

FIG. 10 is an explanatory diagram of a method of calculating the thumbnail display count of FIG. 9;

FIG. 11 is a first explanatory diagram of a method of selecting a display thumbnail page by a display thumbnail selection section of the information processing apparatus shown in FIG. 1;

FIG. 12 is a second explanatory diagram of a method of selecting a display thumbnail page by the display thumbnail selection section of FIG. 11;

FIG. 13 is a diagram showing a relationship between system states, operation information from the user, and a display form of thumbnail images in the information processing apparatus shown in FIG. 1;

FIG. 14 is a diagram showing an example of a scene search screen at normal reproduction in the information processing apparatus shown in FIG. 1;

FIG. 15 is a diagram showing an example of a scene search screen at a time point at which a predetermined period of time has passed since the switching of a time of day of a moving image at normal reproduction without any operation made on thumbnail images by a user, in the information processing apparatus shown in FIG. 1;

FIG. 16 is a diagram showing an example of a scene search screen at high-speed reproduction of a moving image in the information processing apparatus shown in FIG. 1;

FIG. 17 is a diagram for explaining a case where a movement speed of pop-up display does not become constant at high-speed reproduction of a moving image;

FIG. 18 is a diagram for explaining a method of controlling a reproduction speed of a moving image so as to make the movement speed of pop-up display constant in the information processing apparatus shown in FIG. 1;

FIG. 19 is an explanatory diagram on processing of a case where a plurality of thumbnail frames as pop-up display targets are across a plurality of pages in the information processing apparatus shown in FIG. 1;

FIG. 20 is an explanatory diagram on processing of a case where a plurality of thumbnail frames judged as pop-up display targets are across a plurality of rows in the information processing apparatus shown in FIG. 1;

FIG. 21 is a diagram showing an example of a scene search screen in which the degrees of importance of feature frames are reflected on the display form of thumbnail images in the information processing apparatus shown in FIG. 1;

FIG. 22 is a diagram showing a relationship between system states, operation information from a user, and a pop-up display count of thumbnail images in Modified example 1;

FIG. 23 is a diagram showing a scene search screen at 5×-speed reproduction of a moving image in Modified example 1;

FIG. 24 is a diagram showing a scene search screen at 10×-speed reproduction of a moving image in Modified example 1;

FIG. 25 is a diagram showing a scene search screen at 15×-speed reproduction of a moving image in Modified example 1;

FIG. 26 is a diagram showing a scene search screen at 30×-speed reproduction of a moving image in Modified example 1;

FIG. 27 is a diagram showing an example of thumbnail thinning-out processing by an information processing apparatus of Modified example 2; and

FIG. 28 is a flowchart from the selection of a display thumbnail page by a display thumbnail selection section to the thumbnail thinning-out processing of the information processing apparatus shown in FIG. 27.

### DESCRIPTION OF PREFERRED EMBODIMENTS

Hereinafter, an embodiment of the present invention will be described with reference to the drawings.

### First Embodiment

### [Structure of Information Processing Apparatus]

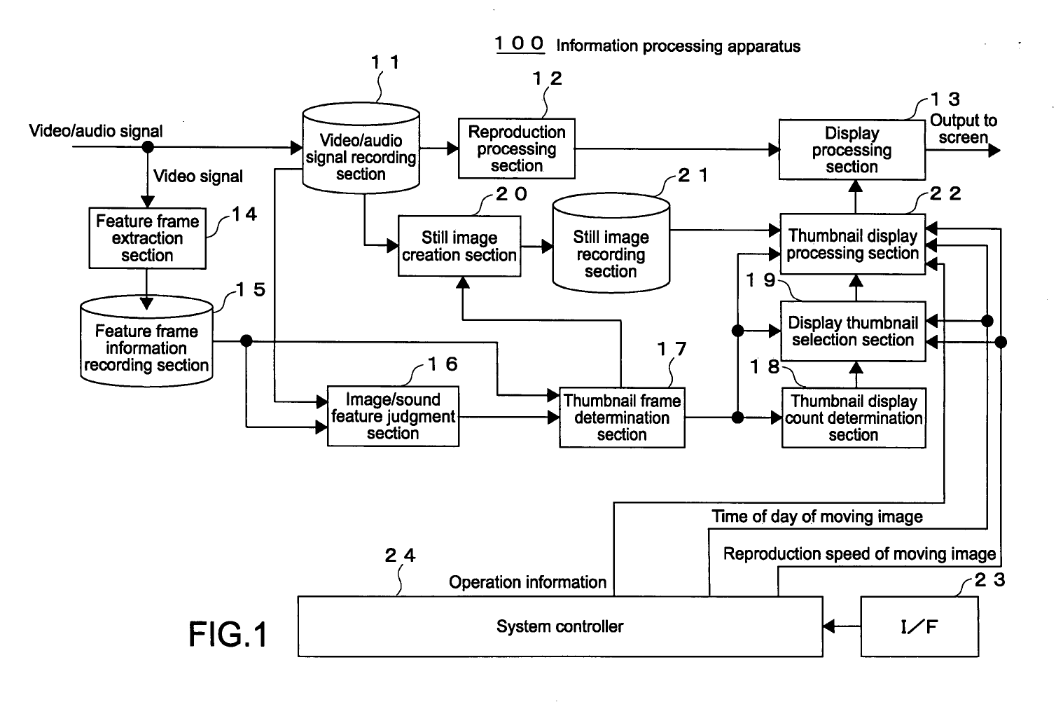

FIG. 1 is a block diagram showing the structure of an information processing apparatus according to a first embodiment of the present invention.

The information processing apparatus of this embodiment is an apparatus capable of receiving moving image content in which at least a video signal and an audio signal are multiplexed via a transmission medium, storing the moving image content, and reproducing video and audio. More specifically, the moving image content in which a video signal and an audio signal are multiplexed refers to, for example, broadcasting waves such as digital terrestrial broadcasting and digital satellite broadcasting, an MPEG (Moving Picture Expert Group)-2 transport stream or the like transmitted via transmission media such as IP (Internet Protocol) lines.

As shown in FIG. 1, an information processing apparatus 100 of this embodiment includes a video/audio signal recording section 11, a reproduction processing section 12, a display processing section 13, a feature frame extraction section 14, a feature frame information recording section 15, an image/sound feature judgment section 16, a thumbnail frame determination section 17, a thumbnail display count determination section 18, a display thumbnail selection section 19, a still image creation section 20, a still image recording section 21, a thumbnail display processing section 22, an I/F section 23, and a system controller 24.

The video/audio signal recording section 11 is a recording area in which a video signal and an audio signal of moving image content acquired in the information processing apparatus 100 are recorded.

The reproduction processing section 12 is a section in which the processing for decoding and reproducing the video signal and the audio signal recorded in the video/audio signal recording section 11 is performed.

The display processing section 13 is a section to generate display data of the video reproduced by the reproduction processing section 12 and thumbnail images created by the thumbnail display processing section 22 described later, and output the display data as a moving image to a display means having a physical screen. The display means having a physical screen may be an external display apparatus connected to the information processing apparatus 100, or may be a display apparatus incorporated in the information processing apparatus 100.

The feature frame extraction section 14 detects a frame of a characteristic scene in the video such as a cut point and a middle point of a fade interval, as a feature frame, from the acquired video signal, and acquires time-of-day information, which is a time position of a frame in moving image content of the feature frame, as “feature frame information”.

The feature frame information recording section 15 is a recording area in which the feature frame information acquired in the feature frame extraction section 14 is recorded.

The image/sound feature judgment section 16 (importance degree calculation section) is a section that calculates the degree of importance in which the intensity of the feature is quantified based on a video signal and an audio signal for each feature frame corresponding to the feature frame information recorded in the feature frame information recording section 15.

The thumbnail frame determination section 17 (selection section) determines one or more frames of thumbnail targets as “thumbnail frames” based on the degree of importance of each feature frame, and outputs time-of-day information that is a time position of a thumbnail frame in moving image content, set as “thumbnail frame information”, to the thumbnail display count determination section 18.

The thumbnail display count determination section 18 (division section) determines the number of thumbnails displayed in one screen to be “thumbnail display count” for each page, based on the thumbnail frame information or the like supplied from the thumbnail frame determination section 17, so as to divide all the thumbnail frames in unit of pages constituted of groups of a plurality of thumbnail frames that are continuous in a time sequence. Then, the thumbnail display count determination section 18 supplies the thumbnail display count in each page and the thumbnail frame information for each page to the display thumbnail selection section 19.

The display thumbnail selection section 19 (thumbnail display processing section) is a section that sets a thumbnail frame positioned closest to a time of day of a moving image being reproduced to be a “latest thumbnail frame” and selects thumbnail frames in units of pages, which include the latest thumbnail frame, as display targets of thumbnail images.

The still image creation section 20 is a section that creates still images corresponding to the thumbnail frames determined by the thumbnail frame determination section 17, using the video signal recorded in the video/audio signal recording section 11.

The still image recording section 21 is a recording area in which a still image for each thumbnail frame created by the still image creation section 20 is recorded.

The thumbnail display processing section 22 (thumbnail display processing section) creates thumbnail images for the thumbnail frames in units of pages that include the latest thumbnail frame selected by the display thumbnail selection section 19, using corresponding still images recorded in the still image recording section 21. Further, by connecting the thumbnail images in units of pages to one another in a form arranging the thumbnail images in a matrix in a time sequence, for example, the thumbnail display processing section 22 supplies the resultant to the display processing section 13.

The I/F section 23 (reproduction speed input section) is an interface that receives inputs of various types of operation information from a user, such as switching between on/off of thumbnail display, a reproduction speed (search speed) of a moving image, selection of a thumbnail frame for designating a reproduction position of a moving image, and supplies the inputs to the system controller 24. Specifically, a key input apparatus, a mouse, a touch panel sensor, a remote controller, or the like may be used as the interface.

The system controller 24 performs control or the like on thumbnail display based on various types of operation information input by the user via the I/F section 23, for example.

The above-mentioned sections of the information processing apparatus 100 are implemented by, more specifically, a CPU (Central Processing Unit), a typical computer hardware including a main memory, and a program that operates the computer hardware. More specifically, the video/audio signal recording section 11, the feature frame information recording section 15, and the still image recording section 21 are storage apparatuses such as a main memory, an HDD (Hard disk drive), an SDD (Solid State Drive), and an ODD (Optical Disc Drive).

It should be noted that the information processing apparatus 100 includes a broadcast signal processing section in addition to the structure shown in FIG. 1. The broadcast signal processing section includes a broadcast reception section and a signal processing section. The broadcast reception section receives a digital broadcast signal via a transmission medium, and the signal processing section splits the received digital broadcast signal into a video signal and an audio signal of moving image content. More specifically, the broadcast reception section described above is a tuner that selects a channel and receives a digital broadcast signal via an antenna through broadcast media such as terrestrial waves and satellite waves, from a broadcast station, or an IP network connection section that receives an IP multicast signal via an IP (Internet Protocol) line.

In the information processing apparatus 100 of this embodiment, thumbnail images corresponding to frames with particularly higher degrees of importance out of the feature frames are arranged and displayed in a time sequence so as to enable the user to perform a scene search of moving image content, and in particular, a time of day of a scene the user wants to confirm can be designated by selecting a thumbnail image. When a thumbnail image is selected by the user, the reproduction time of the moving image is jumped to a time of day of a thumbnail frame corresponding to the thumbnail image in question, and the moving image is continuously reproduced from that time of day. The information processing apparatus 100 of this embodiment is intended to perform such a scene search using thumbnail images in more excellent manner, and particularly, has been made to focus on a display system of thumbnail images at a time when a moving image is reproduced at high speed to perform a scene search.

### [Outline of Operation of Information Processing Apparatus 100]

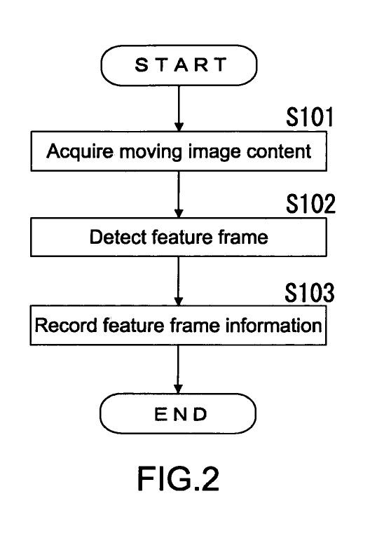

Next, with reference to FIGS. 2 to 4, the outline of operation of thumbnail display processing by the information processing apparatus 100 of this embodiment will be described.

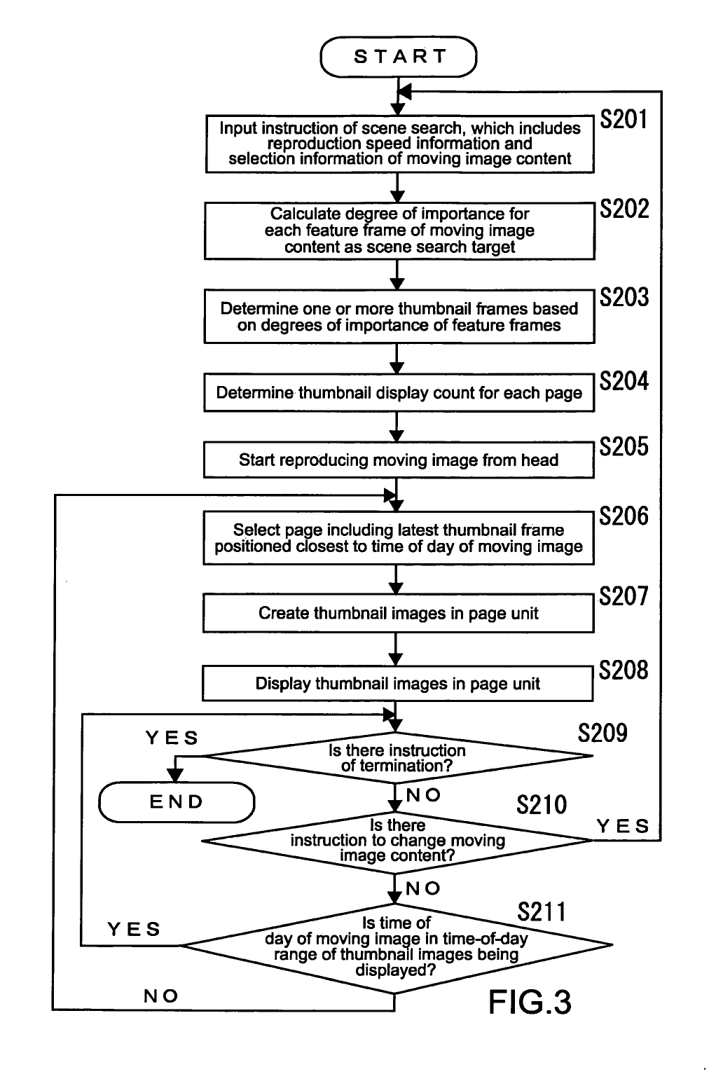

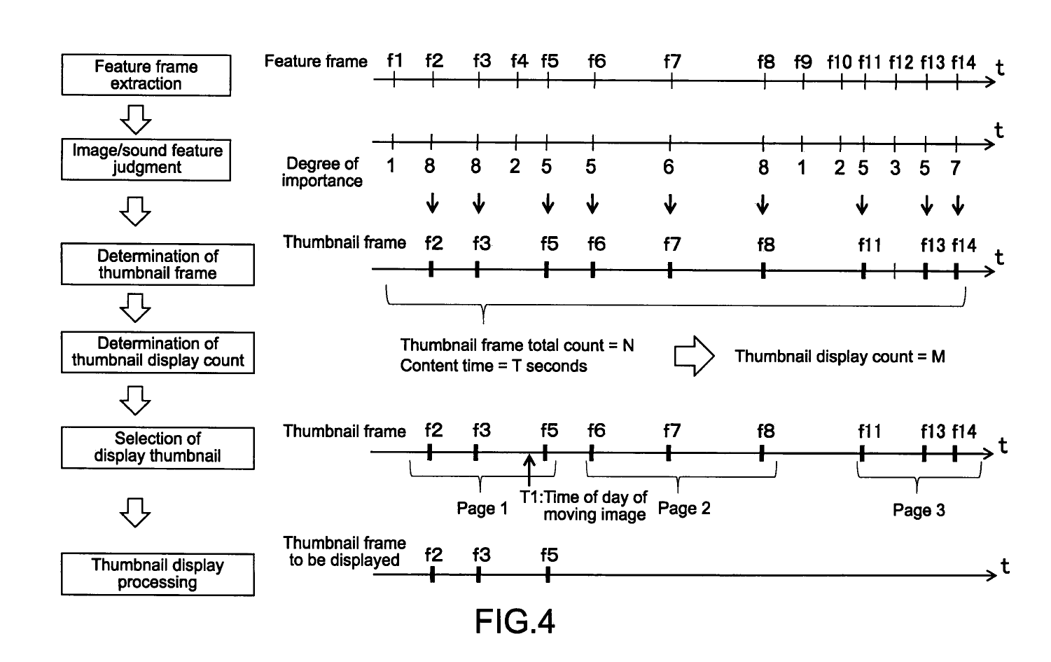

FIG. 2 is a flowchart on detection of a feature frame of moving image content by the information processing apparatus 100 of this embodiment. FIG. 3 is a flowchart on thumbnail display processing by the information processing apparatus 100 of this embodiment. FIG. 4 is a timing chart of an example of the thumbnail display processing. In FIG. 4, t represents a time axis of moving image content.

First, in the flowchart of FIG. 2, the information processing apparatus 100 receives moving image content and splits the received moving image content into a video signal and an audio signal in the broadcast signal processing section (not shown) (Step S101). The video signal and audio signal of the moving image content thus obtained are recorded in the video/audio signal recording section 11 and the video signal is supplied to the feature frame extraction section 14 at the same time.

The feature frame extraction section 14 detects a feature frame such as a cut point and a middle point of a fade interval (middle point between fade-in point and fade-out point) from the video signal (Step S102). The feature frame extraction section 14 records the time-of-day information of the detected feature frame, which is a time position in moving image content, as feature frame information, in the feature frame information recording section 15 in association with designation information of the moving image content (Step S103). In the feature frame information recording section 15, pieces of feature frame information for pieces of moving image content are recorded. FIG. 4 shows a case where feature frames f1 to f14 are detected. In this way, the feature frames are positioned at irregular time positions (times of day) on the time axis t of moving image content. It should be noted that the feature frame information recording section 15 can record not only feature frame information of one moving image content, but also feature frame information of pieces of moving image content.

Hereinafter, the user can designate moving image content, a scene search of which is intended to be executed by the user, from moving image content whose feature frame information is recorded in the feature frame information recording section 15, and give an instruction to perform a scene search.

Next, in the flowchart of FIG. 3, it is assumed that the user inputs operation information to instruct activation of a scene search, which includes designation information of moving image content of a scene search target and reproduction speed information (search speed information), to the system controller 24 via the I/F section 23 (Step S201). It should be noted that the reproduction speed (search speed) can be freely selected by the user, for example, per 1× speed, from normal reproduction (normal speed=1× speed) to high-speed reproduction such as n× speed.

Upon reception of the operation information to instruct activation of a scene search, the system controller outputs an activation command including the designation information of the moving image content to the image/sound feature judgment section 16. When receiving the activation command, the image/sound feature judgment section 16 reads feature frame information of corresponding moving image content from the feature frame information recording section 15 based on the designation information of the moving image content. The image/sound feature judgment section 16 reads a video signal and an audio signal of a feature frame of a corresponding time of day from the video/audio signal recording section 11 based on the respective pieces of feature frame information, and calculates the degree of importance of each feature frame (Step S202). For example, in FIG. 4, the degrees of importance 1 to 8 are given to the feature frames f1 to f14. The value 1 is a minimum value of the degree of importance, and the value 8 is a maximum value of the degree of importance. A specific method of calculating the degree of importance of the feature frame will be described later. The image/sound feature judgment section 16 supplies the calculated degree of importance for each feature frame to the thumbnail frame determination section 17.

The thumbnail frame determination section 17 determines a thumbnail frame based on the degree of importance of the feature frame, supplied from the image/sound feature judgment section 16, and outputs the information indicating a time position of the thumbnail frame, as thumbnail frame information, to the display thumbnail selection section 19, and notifies the thumbnail display count determination section 18 of the total number of thumbnail frames (Step S203). For example, in FIG. 4, feature frames having the degree of importance equal to or larger than 5 are determined as thumbnail frames. As a result, the feature frames f2, f3, f5, f6, f7, f8, f11, f13, and f14 are determined as thumbnail frames. A more specific method of determining a thumbnail frame will be described later.

Next, the thumbnail display count determination section 18 determines the number of thumbnails displayed on one screen as a “thumbnail display count” based on the total number of thumbnail frames or the like supplied from the thumbnail frame determination section 17, so as to divide all the thumbnail frames in units of pages constituted of groups of a plurality of thumbnail frames that are continuous in a time sequence (Step S204). Then, the thumbnail display count determination section 18 supplies the thumbnail display count to the display thumbnail selection section 19. For example, in FIG. 4, a thumbnail display count M is obtained from a thumbnail frame total count N, a content time length T, or the like. It should be noted that a specific method of determining a thumbnail display count will be described later.

After the thumbnail display count is determined, the system controller 24 instructs the reproduction processing section 12 to reproduce a moving image for a scene search of the moving image content. Upon reception of the instruction, the reproduction processing section 12 reads the video signal of the moving image content from the video/audio signal recording section 11 to decode it, and starts reproducing the moving image from the head thereof (Step S205).

On the other hand, the display thumbnail selection section 19 divides the thumbnail frame information supplied from the thumbnail frame determination section 17 into thumbnail frame information in a page unit based on the thumbnail display count from the thumbnail display count determination section 18. When the moving image starts to be reproduced, the display thumbnail selection section 19 judges a thumbnail frame positioned closest to the time of the moving image being reproduced to be a “latest thumbnail frame”, and supplies thumbnail frame information in a page unit that includes the latest thumbnail frame to the thumbnail display processing section 22 (Step S206). For example, in FIG. 4, the feature frame f5 positioned closest to a time of day T1 of the moving image is judged to be the latest thumbnail frame, and thumbnail frame information of M pieces of thumbnail frames f2, f3, and f5 belonging to the page 1 including the latest thumbnail frame f5 are supplied to the thumbnail display processing section 22. It should be noted that in the example of FIG. 4, the number of thumbnail frames in a page unit is set to 3, but the thumbnail images are arranged in a matrix in reality and the value M of the thumbnail display count is a value of R×C, in which the number of columns in the matrix is R and the number of rows in the matrix is C.

Then, the thumbnail display processing section 22 receives the thumbnail frame information in a page unit from the display thumbnail selection section 19, and then reads a still image of a feature frame of a corresponding time of day from the still image recording section 21 based on each piece of thumbnail frame information. Then, the thumbnail display processing section 22 creates thumbnail images from the read still images and supplies the thumbnail images to the display processing section 13 (Step S207). A specific method of creating a thumbnail image will be described later.

The display processing section 13 creates display data of the thumbnail images in a page unit supplied from the thumbnail display processing section 22, and outputs the display data to a physical display means. Accordingly, the thumbnail images in a page unit that correspond to a time of day of the moving image being reproduced are displayed on the screen (Step S208).

After that, the system controller 24 checks whether there is an instruction to terminate the scene search from the user (Step S209). In a case where there is no instruction to terminate the scene search from the user (NO in Step S209), the system controller 24 then checks whether there is an instruction to change moving image content as a scene search target (Step S210). In a case where there is no instruction to change moving image content as a scene search target (NO in Step S210), the system controller 24 notifies the display thumbnail selection section 19 of a time of day of the moving image being reproduced.

When acquiring the time of day of the moving image, the display thumbnail selection section 19 judges whether the time of day falls in the time-of-day range of thumbnail images (thumbnail frames) in a page unit being currently displayed (Step S211). If the time of day of the moving image falls in the time-of-day range of the thumbnail images in a page unit being currently displayed (YES in Step S211), the display thumbnail selection section 19 judges that the display of the thumbnail images does not need to be updated, and continues a current display state of the thumbnail images. After that, the display thumbnail selection section 19 returns to Step S209 again to judge whether there is an instruction to terminate the scene search from the user.

On the other hand, in a case where the time of day of the moving image being reproduced does not fall in the time-of-day range of thumbnail images in a page unit being currently displayed (NO in Step S211), the display thumbnail selection section 19 returns to Step S206 again to supply thumbnail frame information in a page unit that includes the latest thumbnail frame to the thumbnail display processing section 22. As a result, in Step S208, thumbnail images in a new page unit that correspond to the time of day of the moving image being reproduced are displayed on the screen and the display of the thumbnail frames is updated.

Further, in Step S210, in a case where the system controller 24 judges that an instruction to change moving image content of a scene search target is generated (YES in Step S210), the system controller 24 returns to Step S201 and receives an input from the user, which is operation information to instruct activation of a scene search, including designation information of moving image content as a new scene search and reproduction speed information (search speed information). The operations hereinafter are the same as those described above.

Then, when receiving an instruction to terminate the scene search via the I/F section 23 from the user in Step S209 (YES in Step S209), the system controller 24 terminates the reproduction of the moving image and the display of the thumbnail images.

Next, the image/sound feature judgment, the thumbnail frame determination, the thumbnail display count determination, the selection of display thumbnail page, and the thumbnail display processing will be described in detail.

### [Image/Sound Feature Judgment 1]

The degree of importance of a feature frame can be obtained from the details of a moving image (video and audio) of the feature frame. Examples of the feature frame with a high degree of importance include the following frames.
Feature frame including a human face
Feature frame including character information such as a telop
Feature frame immediately after the start of a chapter
Feature frame of a midway through the peak of an audio
Feature frame with high attractiveness (conspicuous color)
Feature frame including many areas with details

For example, it may be possible to preset the degrees of importance for the features of the respective feature frames, and set the sum of the degrees of importance of all the features included on one feature frame to be a calculation result of the degree of importance of the feature frame. However, feature frames in CM or those immediately after fade-out are out of the calculation target of the degree of importance.

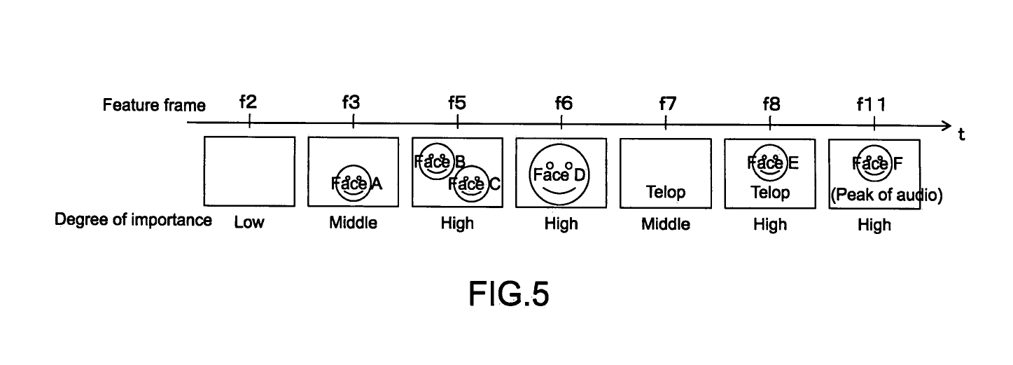

FIG. 5 is a diagram showing a calculation example of the degree of importance of a feature frame. Here, the degree of importance is obtained in three stages of “low”, “middle”, and “high”. For example, the feature frame f3 includes one face and therefore the degree of importance thereof is set to “middle”. The feature frame f5 includes two faces and therefore the degree of importance thereof is set to “high”. In this way, the number of faces may be reflected on the degree of importance. Further, the feature frame f6 includes only one face but the face occupies the feature frame at a high proportion, so the degree of importance thereof is set to “high”. The feature frame f7 includes a telop and therefore the degree of importance thereof is set to “middle”. The feature frame f8 includes a telop and one face, so the degree of importance thereof is set to “high”. The feature frame f11 includes one face and is midway through the peak of an audio, so the degree of importance thereof is set to “high”.

### [Image/Sound Feature Judgment 2]

The image/sound feature judgment section 16 may obtain the degree of importance of a feature frame from a correlation between the feature frame and a past feature frame. For example, the following rules are conceived.
Rule 1: Set the degree of importance of a feature frame expressing a new face unlike a past feature frame to “high”.
Rule 2: Set the degree of importance to “high” in a case where it is a feature frame in which a face that has appeared in a past feature frame appears again and a time difference between the feature frames is equal to or larger than a threshold value.
Rule 3: Set the degree of importance to “middle” in a case where it is a feature frame in which a face that has appeared in a past feature frame appears again and the backgrounds of the feature frames are different from each other.
Rule 4: Set the degree of importance to “low” in a case where it is a feature frame in which a face that has appeared in a past feature frame appears again and the backgrounds of the feature frames are the same.

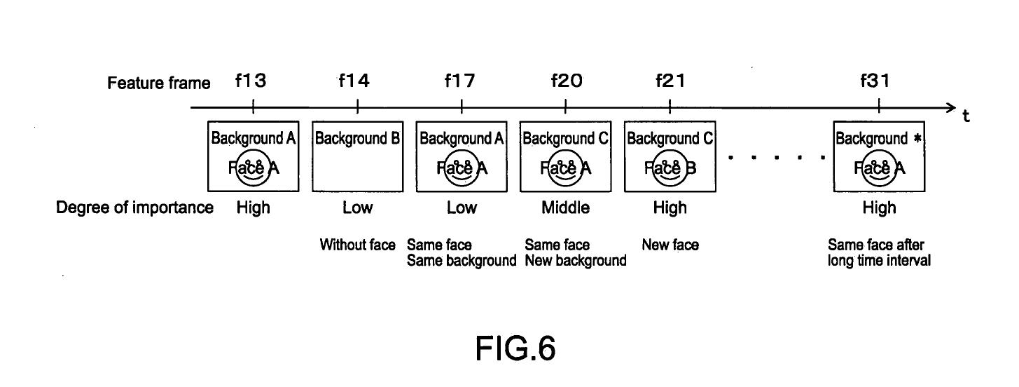

FIG. 6 is a diagram showing a calculation example of the degree of importance of a feature frame based on the rules described above. Here, a feature frame f21 has the degree of importance set to “high” based on the Rule 1. A feature frame f17 has the degree of importance set to “low” based on the Rule 4. A feature frame f20 has the degree of importance set to “middle” based on the Rule 3. Then, a feature frame f31 has the degree of importance set to “high” based on the Rule 2.

### [Image/Sound Feature Judgment 3]

The image/sound feature judgment section 16 may obtain the degree of importance of a feature frame in units of feature frames continuous over a predetermined time interval. For example, the following rules are conceived.
Rule 1: Set the degree of importance of a feature frame to “high”, the feature frame including the person whose entire face or body can be recognized most clearly in continuous feature frames in which one person appears continuously or at a high frequency over a predetermined time interval.
Rule 2: Set the degree of importance of a feature frame to “low”, the feature frame excluding feature frames having the degree of importance set to “high” in the continuous feature frames in the Rule 1.

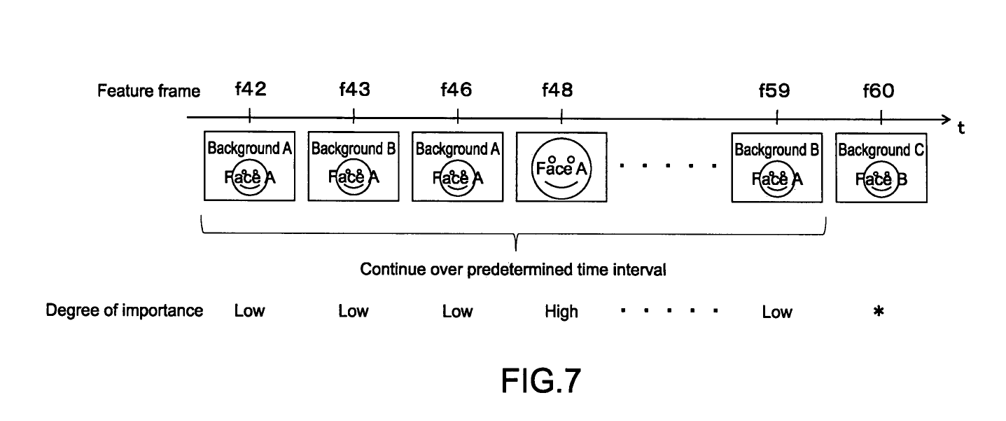

FIG. 7 is a diagram showing a calculation example of the degree of importance of a feature frame based on the rules described above. Here, it is assumed that one person appears continuously or at a high frequency in the interval between a feature frame f42 to a feature frame f59, the time interval exceeds a preset time interval, and a feature frame f48 is a frame in which the entire face of the person can be recognized most clearly. In this case, the feature frame f48 has the degree of importance set to “high” based on the Rule 1, and the feature frames f42 to f59 in the time interval except for the feature frame f48 have the degree of importance set to “low” based on the Rule 2.

### [Determination of Thumbnail Frame]

Specifically, the thumbnail frame determination section 17 determines a feature frame with the degree of importance equal to or larger than a threshold value that is preset to determine a thumbnail frame, as a thumbnail frame. Alternatively, the thumbnail frame determination section 17 may determine a predetermined number of feature frames with higher degrees of importance, as thumbnail frames.

### [Determination of Thumbnail Display Count]

The thumbnail display count determination section 18 determines the number of thumbnail images displayed in one screen as a “thumbnail display count” based on the total number of thumbnail frames or the like supplied from the thumbnail frame determination section 17, so as to divide all the thumbnail frames in units of pages constituted of groups of a plurality of thumbnail frames that are continuous in a time sequence.

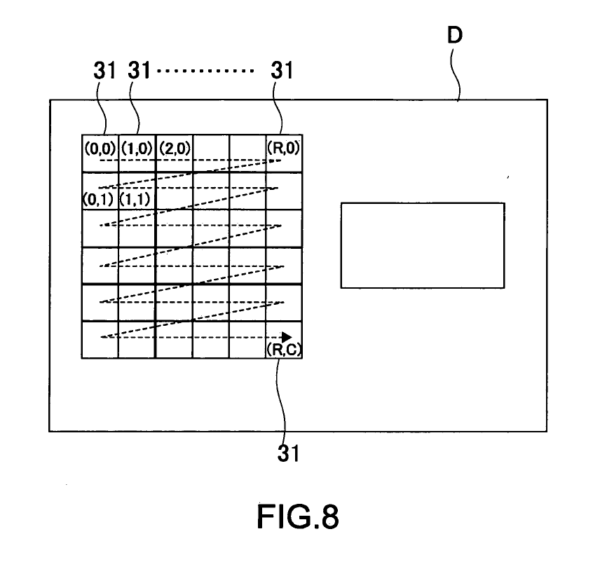

FIG. 8 is a diagram showing a method of arranging thumbnail images in a page unit. As shown in FIG. 8, thumbnail images 31 are arranged in a matrix on a screen D.

The orientation of a time in the matrix is set to, for example, (0,0)→(1,0)→(2,0)→ . . . →(R,0)→(0,1)→(1,1)→ . . . →(R,C) with the upper left end of the matrix as (0,0) and the lower right end thereof as (R,C). Therefore, the number of thumbnail images displayed on one screen (thumbnail display count) is R×C.

Next, an example of a method of calculating the thumbnail display count by the thumbnail display count determination section 18 will be described.

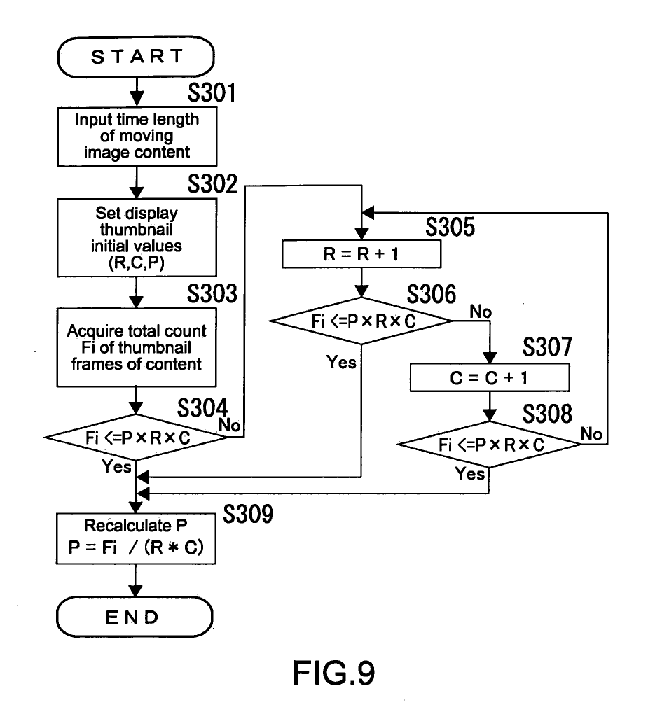

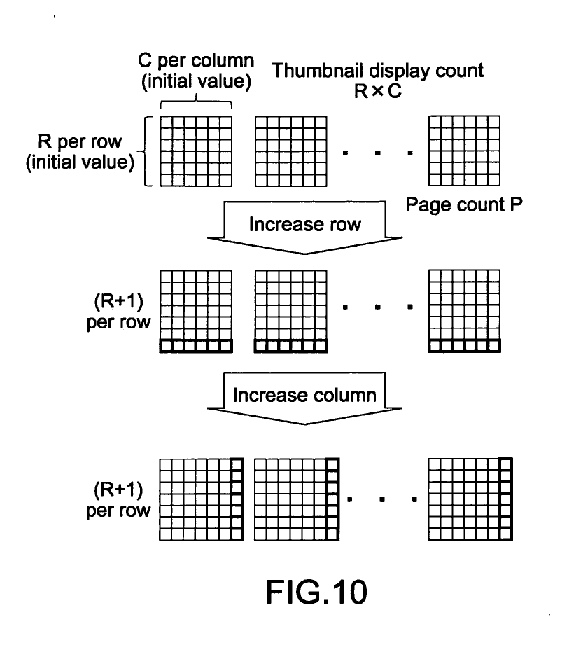

FIG. 9 is a flowchart showing a calculation procedure of a thumbnail display count by the thumbnail display count determination section 18. FIG. 10 is an explanatory diagram of a method of calculating a thumbnail display count FIG. 9. Here, the row count R and the column count C have initial values determined in advance, respectively, and a page count P corresponding to a content time length is also determined in advance.

The thumbnail display count determination section 18 first inputs a time length of the moving image content (Step S201). The information of a time length of the moving image content is contained in program information such as SI (Service Information) and EIT (Event Information Table) distributed by being multiplexed in a video signal in the MPEG-2 transport stream, for example. The information processing apparatus 100 splits the received data signal multiplexed in the MPEG-2 transport stream and decodes it, thus obtaining information of a time length of the moving image content.

Next, the thumbnail display count determination section 18 sets an initial value of the page count P together with initial values of the row count R and the column count C (Step S302). Here, the initial values of the row count R and the column count C are preset values. The initial value of the page count P is also determined in advance in a correlation with a content time length, for example. Therefore, the initial value of the page count P can be obtained from the content time length acquired in Step S301.

Then, the thumbnail display count determination section 18 acquires a total count Fi of thumbnail frames that is determined by the thumbnail frame determination section 17 (Step S303). Then, the thumbnail display count determination section 18 judges whether the row count R, the column count C, the page count P, and the total count Fi of thumbnail frames satisfy the following condition (Step S304).

Fi<=P×R×C (1)

In a case where the condition is not satisfied (Step NO in S304), the thumbnail display count determination section 18 increments the value of the row count R as shown in FIG. 10 (Step S305), and judges again whether the condition is satisfied (Step S306). In a case where the condition is not yet satisfied, the thumbnail display count determination section 18 increments the value of the column count C (Step S307), and judges again whether the condition is satisfied (Step S308). In a case where the condition is not yet satisfied, the thumbnail display count determination section returns to Step S305 and repeats the processing in Steps S305 to S308 thereafter until the condition is satisfied.

When the condition is satisfied, the thumbnail display count determination section 18 recalculates the page count P by the following expression (2) (Step S309).

P=Fi/(R×C) (2)

(where P is rounded off to the whole number.)

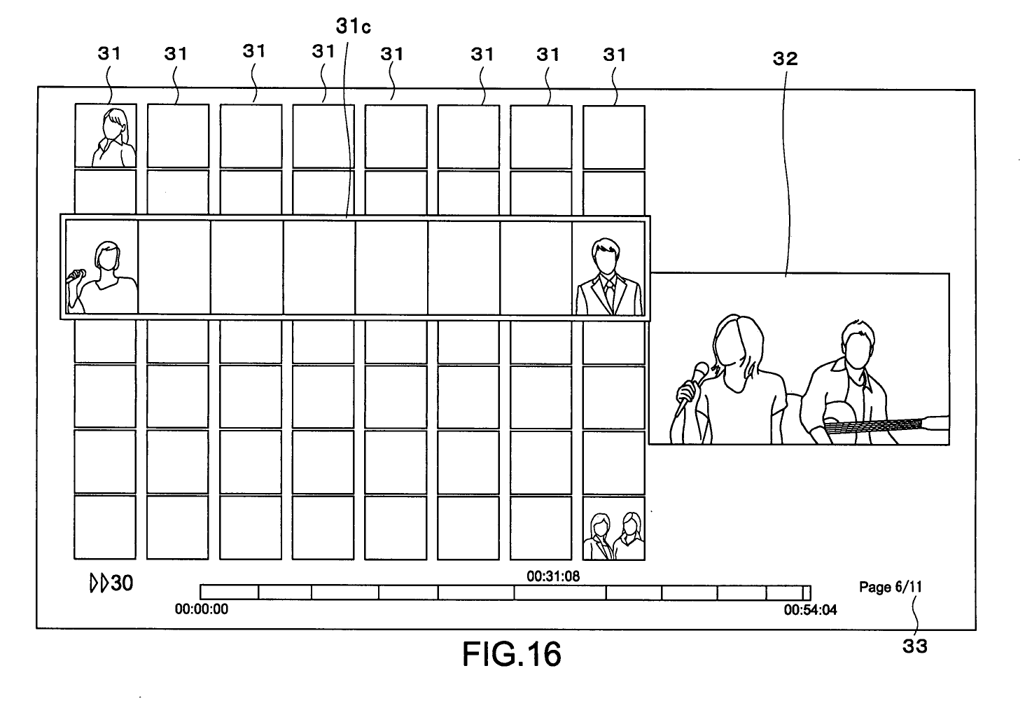

The calculated value P is used as the total page count of the page information (for example, reference numeral in FIG. 16) displayed on a screen in the form of (page number currently displayed on screen)/(total page count).

In this manner, the thumbnail display count (R×C) is determined.

Incidentally, in a case where the display size of one thumbnail image is fixed, when the thumbnail display count (R×C) is increased, there is a probability that all thumbnail images in a page unit are too many to be displayed on a screen. In this regard, it may be possible to make the display size of a thumbnail image variable in accordance with the thumbnail display count (R×C) so as to set the entire thumbnail display area to be substantially constant.

Alternatively, it may also be possible to determine an upper limited value of the thumbnail display count (R×C) in advance, and to increase the page count P in a case where the thumbnail display count (R×C) exceeds the upper limited value determined in advance.

### [Selection of Display Thumbnail Page]

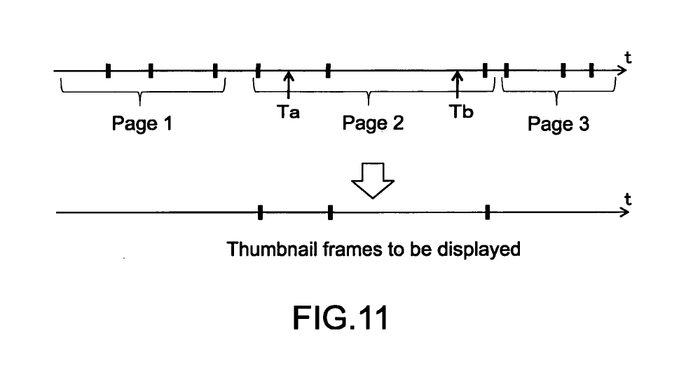

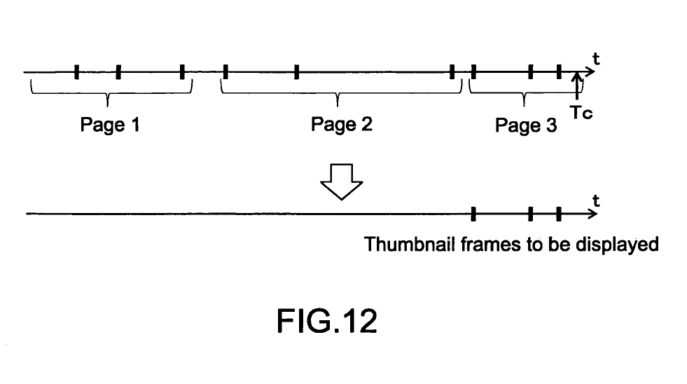

The display thumbnail selection section 19 selects a page displaying that the time of day T1 of the moving image being reproduced is in the time-of-day range of the page 1 including the thumbnail images being displayed (hereinafter, referred to as “display thumbnail page”) as shown in FIG. 4. Therefore, for example, as shown in FIG. 11, even when the time of day of the moving image being reproduced advances from Ta to Tb, those two times of day Ta and Tb of the moving image are in the time-of-day range of the same page 2, with the result that the display thumbnail page is not changed. After that, for example, as shown in FIG. 12, when the time of day of the moving image being reproduced advances from Tb to Tc, since the time of day Tc is in the time-of-day range of a page 3, the display thumbnail page is changed to the page 3 from the page 2. As described above, since the thumbnail images are displayed by switching in a page unit, the user can perform a scene search by associating the respective thumbnail images in a display thumbnail page with display positions thereof in his/her memory, and consequently the efficiency of the scene search can be improved.

Further, the display thumbnail selection section 19 can forward or return display thumbnail pages one by one in accordance with a page forward instruction or page return instruction, which is input by the user via the I/F section 23. Specifically, a page forward button for receiving a page forward instruction and a page return button for receiving a page return instruction are provided on the screen displaying the display thumbnail page. By operations of those buttons, display thumbnail pages are switched backward and forward one by one. Along with this switching, the page number displayed on the current screen (reference numeral 33 of FIG. 16) is updated, and the moving image being reproduced jumps to a time of day belonging to a display thumbnail page after switching, for example, a time of day of a head thumbnail image of the display thumbnail page after switching. Accordingly, the user can freely switch a display thumbnail page backward and forward and perform a scene search at higher speed.

### [Thumbnail Display Processing]

The thumbnail display processing section 22 creates a thumbnail image based on a still image corresponding thereto recorded in the still image recording section 21 for each thumbnail frame belonging to a display thumbnail page selected by the display thumbnail selection section 19, and generates a display image in which thumbnail images are arranged in a matrix in accordance with the information of the row/column count supplied by the display thumbnail selection section 19. Further, the thumbnail display processing section 22 can reflect the degree of importance of a feature frame or the like on a display form of the thumbnail images, or individually change the display form of the thumbnail images based on a system state and operation information from the user. Accordingly, the user who performs a scene search can immediately recognize a thumbnail image with a higher degree of importance among the thumbnail images, thus efficiently performing a scene search.

Examples of the processing of creating a thumbnail image from a still image are as follows.
The thumbnail display processing section 22 generates a thumbnail image by simply reducing the size of a still image.
The thumbnail display processing section 22 cuts out only the center portion from a still image, reduces the size thereof, and sets the resultant image as a thumbnail image. In this case, the thumbnail display processing section cuts out the center portion from a still image into a square at a ratio of 1:1 (length:width) or into a rectangle at a ratio of 4:3 (length:width), or at an optimum ratio corresponding to the thumbnail display count, and sets the resultant image as a thumbnail image.
The thumbnail display processing section 22 generates an image obtained by cutting out an important portion such as a face portion of a person and character information like a telop from a still image into a rectangle and reducing the size thereof as a thumbnail image.

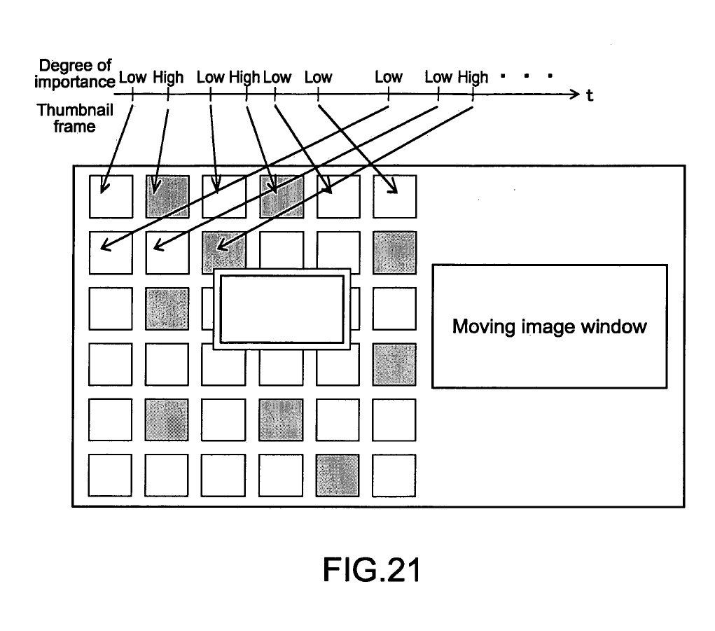

Examples of the processing of reflecting the degree of importance of a feature frame on a display form of thumbnail images are as follows. FIG. 21 is a diagram showing an example of a scene search screen in which the degrees of importance of feature frames are reflected on the display form of thumbnail images.
The thumbnail display processing section 22 limits color information that expresses images, with respect to images with lower degrees of importance. For example, thumbnail images with higher degrees of importance are set as color images and thumbnail images with lower degrees of importance are set as black-and-white images.
The thumbnail display processing section 22 applies a large amount of blurring processing to images with lower degrees of importance. For example, thumbnail images with higher degrees of importance are set as clear images and thumbnail images with lower degrees of importance are blurred.

### [Display Form of Thumbnail Images]

Next, an example of the processing of changing a display form of thumbnail images based on a system state and operation information from the user will be described.

As system states related to the display form of thumbnail images, for example, there are a normal reproduction state and a high-speed reproduction state (high-speed search). At normal reproduction, thumbnail images in a page unit are displayed with a moving image reproduced at 1× speed. At high-speed reproduction (high-speed search), thumbnail images in a page unit are displayed with a moving image reproduced at high speed. Those system states are updated by the operation information from the user. The operation information from the user includes, for example, operation information for selecting one thumbnail image among the thumbnail images in a page unit and operation information for indicating a reproduction speed of a moving image. The reproduction speed of a moving image includes 1× speed for normal reproduction and N× speed for fast-forward or fast-reverse reproduction.

The thumbnail display processing section 22 can change the display form of thumbnail images as follows, based on the operation information from the user and the system states.

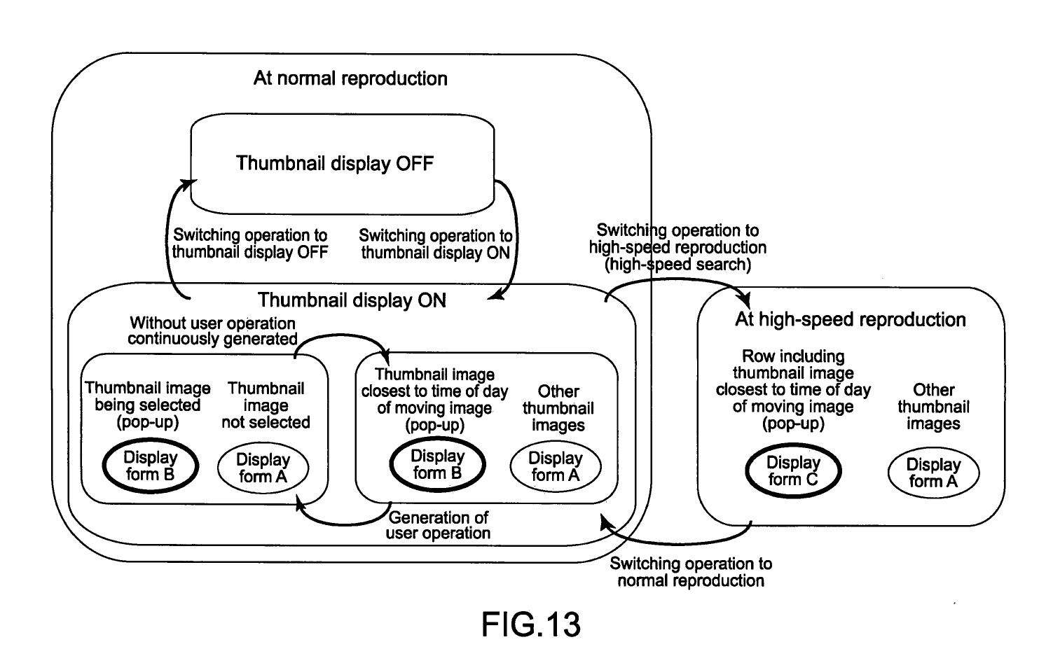

FIG. 13 is a diagram showing a relationship between the system states, the operation information from the user, and the display form of thumbnail images.

For example, when a thumbnail image at any time of day is selected by an operation made by the user using an operation means such as a cross-hair cursor key, a mouse, and a touch sensor panel at normal reproduction, the operation information related to the selection of the thumbnail image is notified to the thumbnail display processing section 22 via the system controller 24. The thumbnail display processing section 22 changes, based on the operation information, the display form of a thumbnail image corresponding to the selected time of day from a display form A to a display form B. It should be noted that the scene search only in a moving image can be performed while the thumbnail images are not displayed.

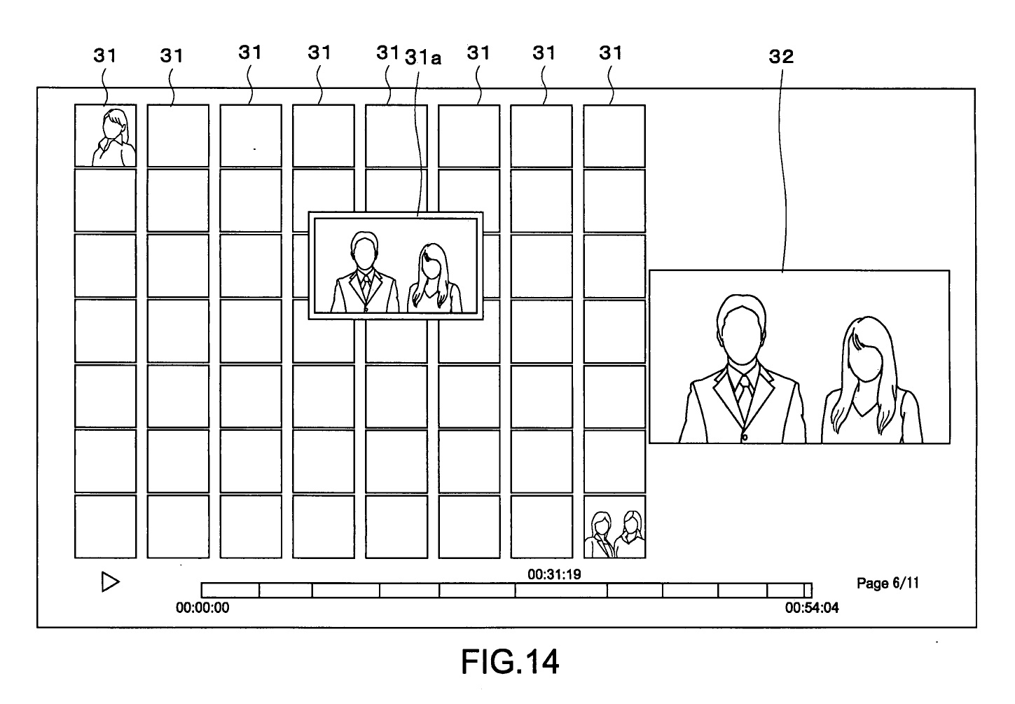

FIG. 14 is a diagram showing an example of a scene search screen at normal reproduction. As shown in FIG. 14, on a scene search screen at the normal reproduction, a plurality of thumbnail images 31 arranged in a matrix and a moving image window 32 as a moving image display area are displayed together. It should be noted that in FIG. 14, thumbnail images are seemed to be present only at the upper left end and lower right end of the matrix, but thumbnail images are displayed in all the positions of the matrix in reality. When any thumbnail image is selected by the user from the plurality of thumbnail images 31 arranged in a matrix, the display form of the thumbnail image is changed from a display form A to a display form B. For example, in FIG. 14, the display form of a thumbnail image 31a is changed to the display form B by being selected by the user. Here, thumbnail images in the display form A are images each obtained by cutting out the center portion from a still image into a square or rectangle and reducing the size thereof, or the like. The thumbnail image in the display form B is obtained by, for example, adding an outer frame to an image that is a size-reduced image of a still image, and is in a so-called “pop-up” display form. The relationship in size between the display forms A and B is B>A.

The system controller 24 notifies the thumbnail display processing section 22 of the operation information related to the selection of a thumbnail image as described above, while notifying the reproduction processing section 12 of a time-of-day information of the selected thumbnail image. The reproduction processing section 12 switches the time of day of a moving image displayed on the moving image window 32 to a time of day notified by the system controller 24, and keeps on the normal reproduction of the moving image. In this manner, at the normal reproduction, by the user operation of selecting any thumbnail image, a moving image can be jumped to a time of day of the thumbnail image.

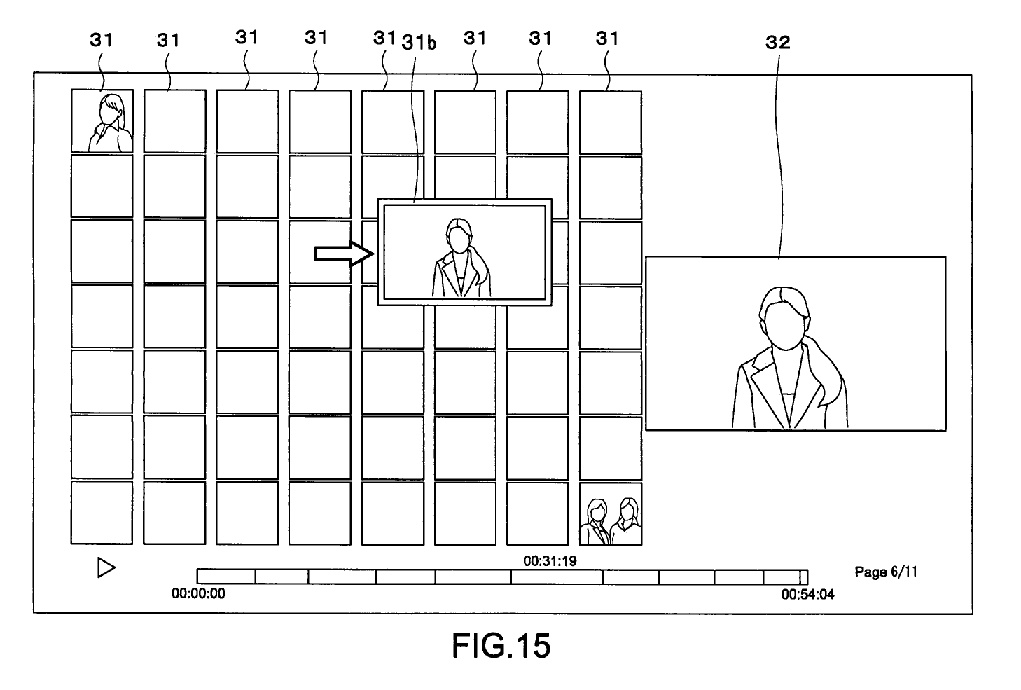

FIG. 15 is a diagram showing an example of a scene search screen at a time point at which a predetermined period of time (about several seconds) has passed since the switching of the time of day of the moving image at the normal reproduction without any operation made on thumbnail images by the user. After the time of day of the moving image is switched, in a case of a state where no operation information related to the scene search is input from the user, the moving image is continuously reproduced as it is at a speed of normal reproduction. Then, the system controller 24 notifies the thumbnail display processing section 22 of a current time of day of the moving image when a predetermined period of time has passed since the switching of the time of day of the moving image, which is instructed by the user. The thumbnail display processing section 22 judges a thumbnail image positioned closest to the time of day of the moving image notified by the system controller 24. In a case where the judged thumbnail image is an image other than the thumbnail image that has been displayed in a pop-up manner, for example, as shown in FIG. 15, the thumbnail display processing section changes the display form of a thumbnail image 31b positioned closest to the time of day of the moving image from the display form A to the display form B and simultaneously changes the display form of the thumbnail image that has been displayed in a pop-up manner from the display form B to the display form A. In this manner, in the plurality of thumbnail images displayed in a page unit, a thumbnail image positioned closest to the time of day of the moving image can be displayed in a pop-up manner.

As described above, the thumbnail image displayed in a pop-up manner is set as a “moving-image-synchronized thumbnail image” that synchronizes a time of day of a moving image, and displayed in a form distinguishable from other thumbnail images being displayed. Accordingly, the user who performs a scene search can grasp a thumbnail image that synchronizes a moving image at a glance and search for a target scene while referring to both the moving image and the thumbnail image. In addition, when the user finds an interesting thumbnail image, the user can efficiently perform a scene search by selecting the thumbnail image to jump the moving image to a time of day of the thumbnail image and confirm details of the scene from the moving image, or the like.

FIG. 16 is a diagram showing an example of a scene search screen at high-speed reproduction of a moving image. At high-speed reproduction of a moving image, a thumbnail image 31c corresponding to one row, which includes a thumbnail image positioned closest to the time of day of the moving image, is displayed in a display form C. The thumbnail image 31c corresponding to one row is obtained by, for example, cutting out the center portion from a still image into a square or rectangle in each of the thumbnail frames of the row, reducing the size thereof, connecting them to each other, and then adding an outer frame to those connected images. It should be noted that at the high-speed reproduction of the moving image, the display form A is also adopted for the display form of thumbnail images 31 other than the thumbnail image 31c corresponding to one row displayed in a pop-up manner. The relationship in size between the display forms A and C is C>A.

### [Control of Movement Speed of Pop-Up Display]

Incidentally, differences between times of day of thumbnail frames that are adjacent in terms of time are distinct. Therefore, generally, a movement speed of pop-up display of thumbnail images at the normal reproduction or high-speed reproduction of a moving image does not become constant.

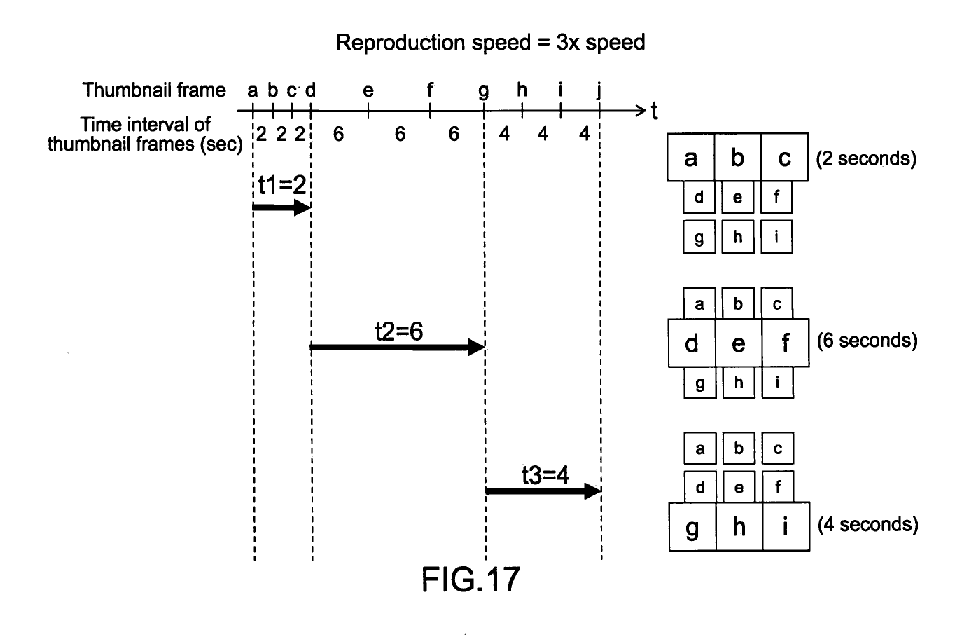

FIG. 17 is a diagram for explaining a case where the movement speed of pop-up display does not become constant at the high-speed reproduction of a moving image. Here, time positions of thumbnail frames a to j are shown on a time axis. There are various distances between the time positions of two thumbnail frames that are adjacent in terms of time (time intervals), but it is assumed in this case that distances between a and b, b and c, and c and d are each set to 2 (seconds), distances between d and e, e and f, and f and g are each set to 6 (seconds), and distances between g and h, h and i, and i and j are each set to 4 (seconds). It is assumed that the number of thumbnail images corresponding to one row is set to 3, a first row includes three thumbnail images a, b, and c, a second row includes three thumbnail images d, e, and f, and a third row includes three thumbnail images g, h, and i. The reproduction speed designated by the user is set to 3× speed.

A row displayed in a pop-up manner is moved in the order of the first row, the second row, and the third row as time passes. In a case where the reproduction speed of the moving image is 3× speed at this time, calculation is made so that a pop-up display time t1 of the first row is 2 seconds (=(2+2+2)/3)), a pop-up display time t2 of the second row is 6 seconds (=(6+6+6)/3)), and a pop-up display time t3 of the third row is 4 seconds (=(4+4+4)/3)).

In other words, the pop-up display time differs depending on the number of thumbnail frames per unit time. The scene search by the user is desirably performed on the thumbnail images by average weight in many cases, and there is a fear that the different length of the pop-up display time for each thumbnail image causes the user to feel uncomfortable. In this regard, in order to make the movement speed of pop-up display constant, a method of controlling a reproduction speed of a moving image in the reproduction processing section 12 is conceived. Next, this method will be described.

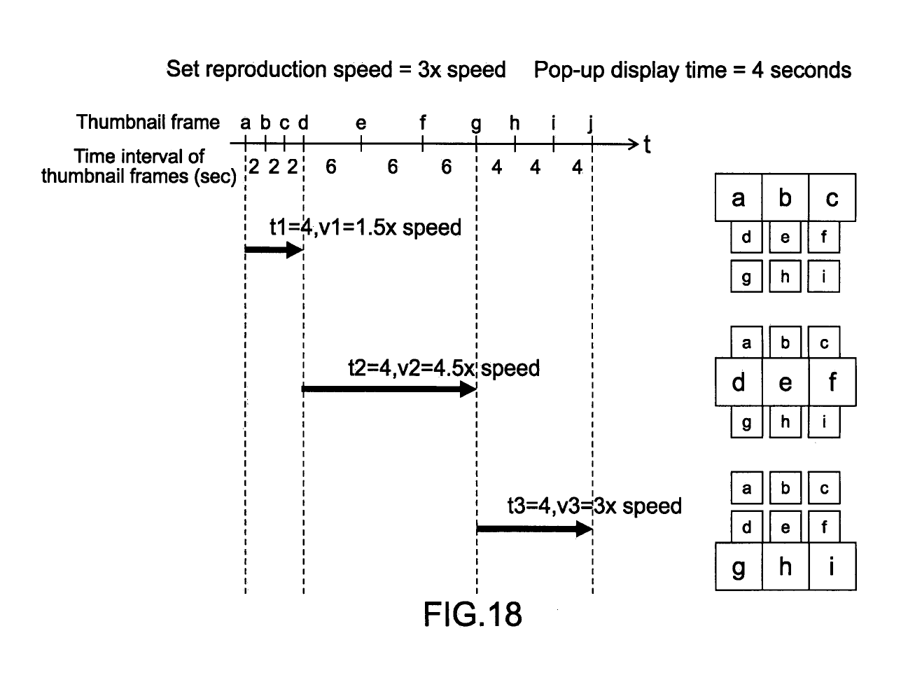

FIG. 18 is a diagram for explaining a method of controlling a reproduction speed of a moving image so as to make the movement speed of pop-up display constant. Here, time positions of the thumbnail frame a to j on the time axis, a distance between the time positions of two thumbnail frames that are adjacent in terms of time (time interval), and a reproduction speed set by the user are the same as the conditions of FIG. 17. However, in this method, a pop-up display time for each row is set in advance. A set value of a pop-up display time can be changed by the user. Here, the pop-up display time is set to 4 (seconds).

Calculations are made as follows:

a reproduction speed v1 of the moving image from the time position of the thumbnail frame a to the time immediately before the time position of the thumbnail frame d is 1.5× speed (=(2+2+2)/4);

a reproduction speed v2 of the moving image from the time position of the thumbnail frame d to the time immediately before the time position of the thumbnail frame g is 4.5× speed (=(6+6+6)/4); and

a reproduction speed v3 of the moving image from the time position of the thumbnail frame g to the time immediately before the time position of the thumbnail frame j is 3.0× speed (=(4+4+4)/4).

In this manner, irrespective of the number of thumbnail frames per unit time, the movement speed of pop-up display can be made constant.

It should be noted that here, though the movement speed of pop-up display is made constant when thumbnail images corresponding to one row are displayed in a pop-up manner, the reproduction speed may be controlled so as to make the movement speed of pop-up display constant in a case where thumbnail images are displayed one by one in a pop-up manner.

Further, the case where the fast-forward reproduction has been described here, but the same holds true for a case of fast-reverse reproduction.

### Modified Example 1

In the embodiment described above, at normal reproduction of a moving image, a thumbnail image corresponding to a thumbnail frame positioned closest to a time of day of a moving image being reproduced is displayed in a pop-up manner, and at high-speed reproduction such as fast-forward or fast-reverse reproduction of a moving image, thumbnail images corresponding to one row including a thumbnail frame positioned closest to a time of day of a moving image being reproduced are displayed in a pop-up manner. However, according to this method, as the number of thumbnail frames corresponding to row in a display thumbnail page becomes larger, it becomes more difficult for the user to understand with which thumbnail frame in the row displayed in a pop-up manner a moving image being reproduced at high speed at a certain time of day is synchronized.

In this regard, in Modified example 1, the number of thumbnail images displayed in a pop-up manner is simultaneously changed in accordance with a reproduction speed of a moving image. For example, in a case where the reproduction speed of a moving image is slow, the number of thumbnail images displayed in a pop-up manner is also simultaneously reduced. Accordingly, it is easier for the user to identify a thumbnail image synchronized with the moving image being reproduced at high speed.

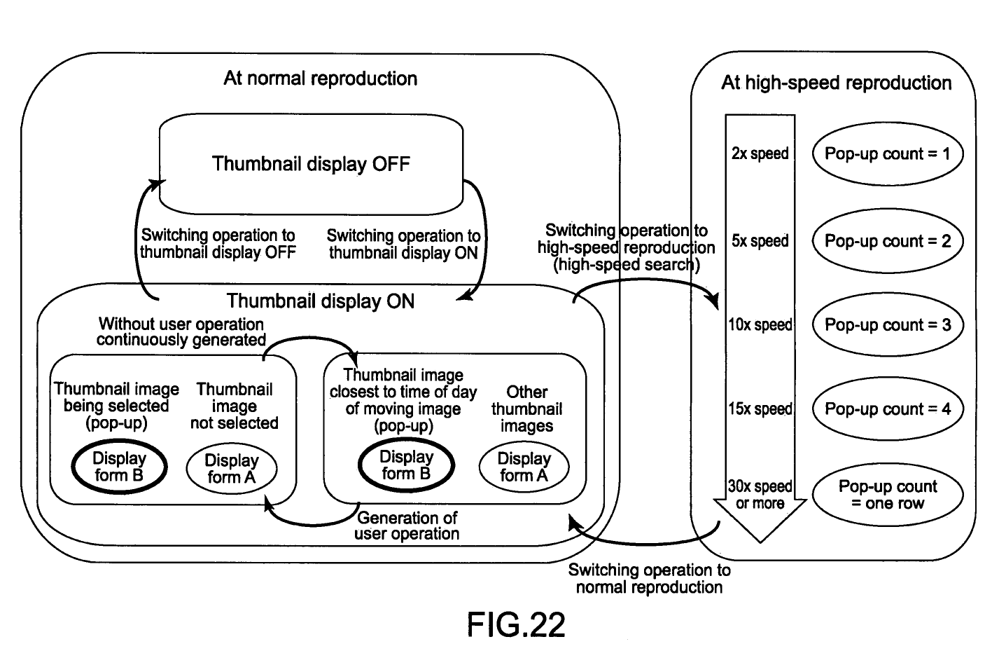

FIG. 22 is a diagram showing a relationship between system states, operation information from the user, and a pop-up display count of thumbnail images in Modified example 1. The details of normal reproduction of a moving image are the same as those in the first embodiment. At the high-speed reproduction, the pop-up display count is changed based on a reproduction speed designated by the user.

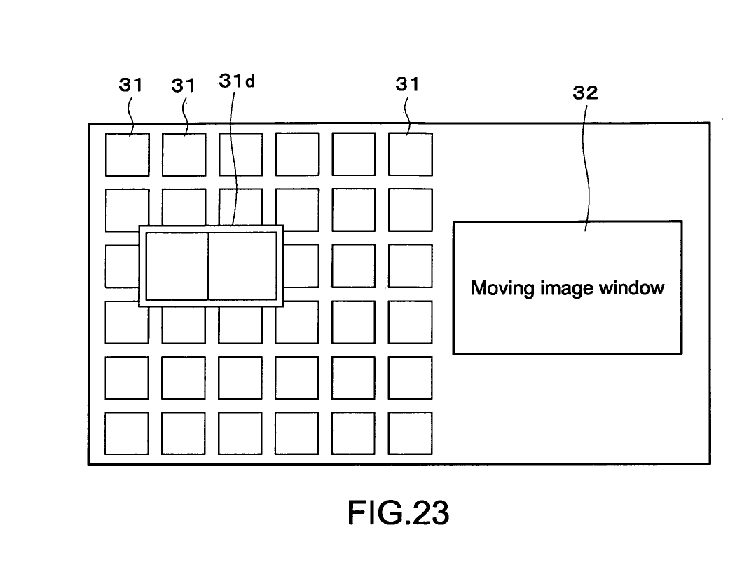

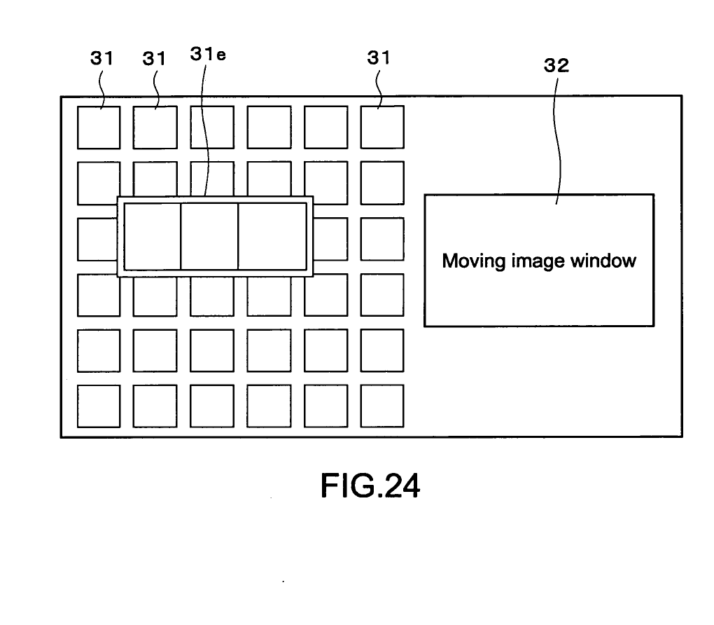

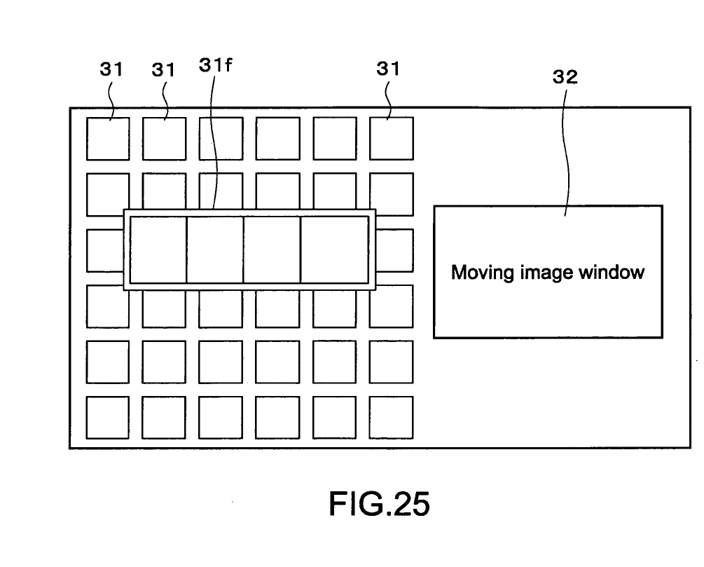

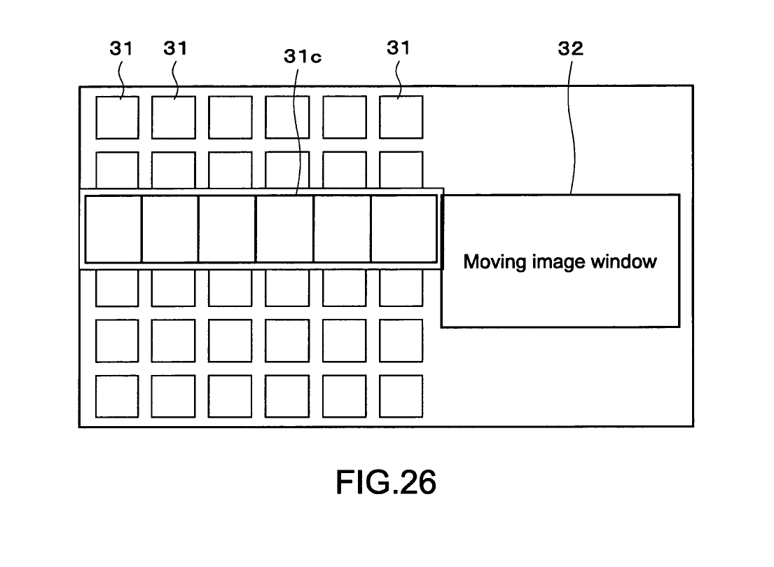

For example, at 2×-speed reproduction, a thumbnail image corresponding to one thumbnail frame positioned closest to a time of day of a moving image is displayed in a pop-up manner as in the case of the normal reproduction. At 5×-speed reproduction, as shown in FIG. 23, an image 31d constituted of a thumbnail image positioned closest to a time of day of the moving image and a thumbnail image of the next time of day is displayed in a pop-up manner. At 10×-speed reproduction, as shown in FIG. 24, an image 31e constituted of a thumbnail image positioned closest to a time of day of the moving image and two thumbnail images immediately before and after the former thumbnail image is displayed in a pop-up manner. At 15×-speed reproduction, as shown in FIG. 25, an image 31f constituted of a thumbnail image positioned closest to a time of day of the moving image, a thumbnail image immediately before the former thumbnail image, and two continuous thumbnail images immediately after the former thumbnail image is displayed in a pop-up manner. Further, at 30×-speed reproduction, as shown in FIG. 26, a thumbnail image 31c corresponding to one row including a thumbnail image positioned closest to a time of day of the moving image is displayed in a pop-up manner.

As a matter of course, the relationship between the speed value and a pop-up display count is not limited to the above examples. Further, at the high-speed reproduction, thumbnail images corresponding to a plurality of rows may be displayed in a pop-up manner.

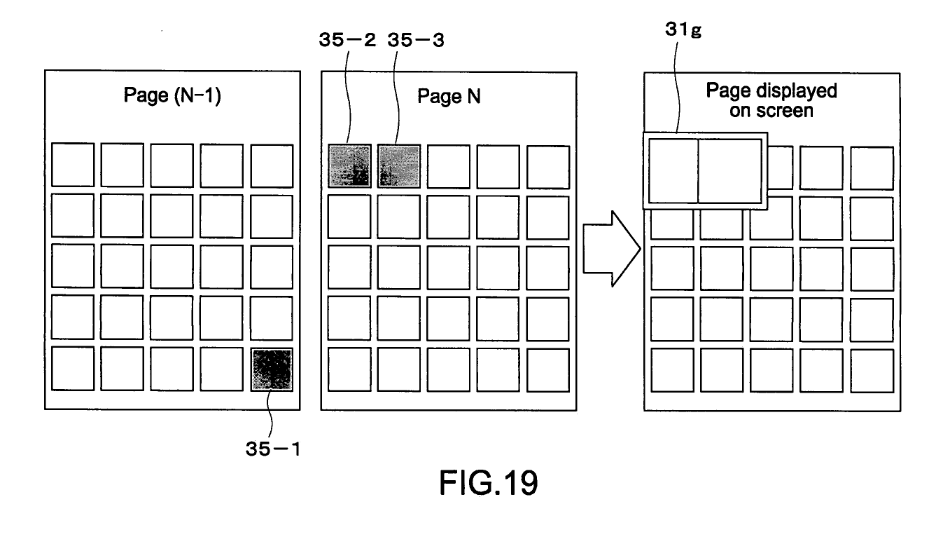

Next, there is described a case where a plurality of thumbnail frames as pop-up display targets are present over a plurality of pages. In this case, the thumbnail display processing section 22 sets only thumbnail frames as pop-up display targets to be valid, which belong to a page having more thumbnail frames as pop-up display targets. For example, as shown FIG. 19, in a case where a pop-up display count is judged and set to 3 and a thumbnail frame positioned closest to a time of day of a moving image is present at the head (or end) of pages, the thumbnail display processing section 22 sets only thumbnail frames 35-2 and 35-3 as pop-up display targets that are belong to a page N to be valid, and generates a thumbnail image 31g thereof. The same holds true for a case where a pop-up count is an odd number of 5 or more. In a case where the number of thumbnail frames as pop-up display targets across a plurality of pages is an even number, it may also be possible to set only thumbnail frames belonging to a predetermined one of front and back pages to be valid.

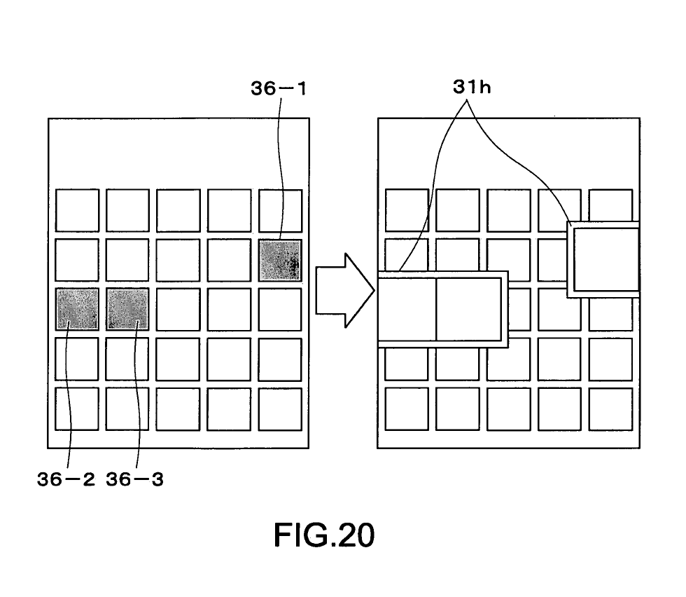

It should be noted that in a case where the pop-up display count is controlled in accordance with a reproduction speed, a plurality of thumbnail frames judged as pop-up display targets may be across a plurality of rows in some cases. In such a case, as shown in FIG. 20, the thumbnail display processing section 22 displays a thumbnail image 31h corresponding to all thumbnail frames in a pop-up manner while maintaining the state of the thumbnail frames across the plurality of rows.

### Modified Example 2

### Selection of Display Thumbnail Page with Thumbnail Thinning-Out Processing

The display thumbnail selection section 19 may select a page including a latest thumbnail frame that is positioned closest to a time of day of a moving image being reproduced, as a display thumbnail page, during the high-speed reproduction of a moving image such as fast-forward reproduction or fast-reverse reproduction, and perform thinning-out on some thumbnail frames in the selected display thumbnail page in accordance with the reproduction speed information (search speed information) to reduce the thumbnail display count. More specifically, the display thumbnail selection section 19 raises a thinning-out ratio and reduces the thumbnail display count, as the reproduction speed is higher.

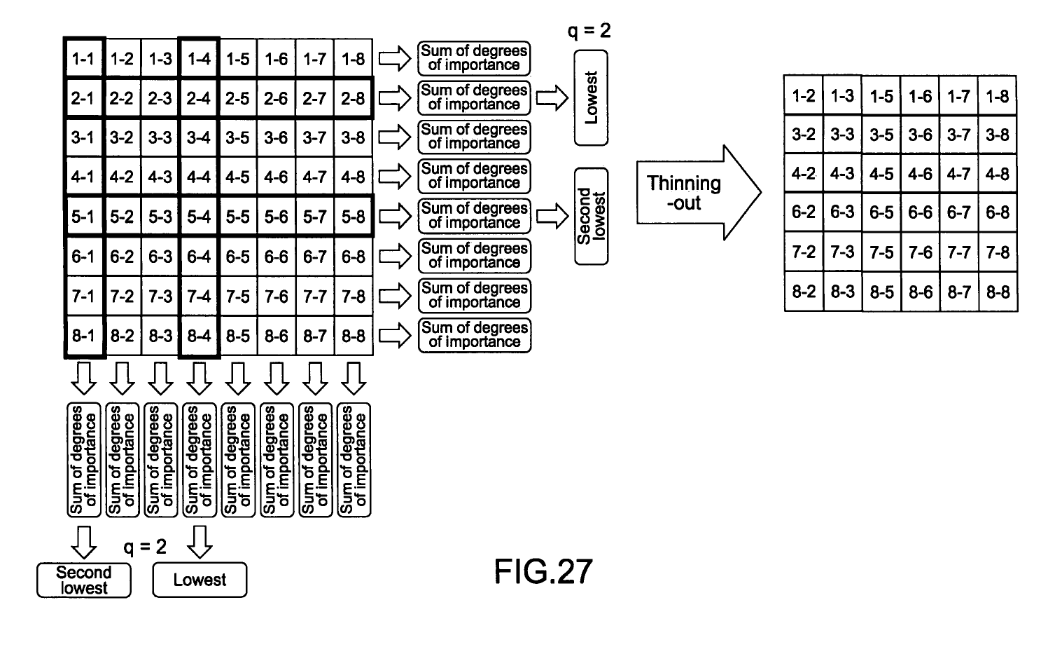

FIG. 27 is a diagram showing an example of the thumbnail thinning-out processing.

Here, the thumbnail display count is assumed to be 8×8=64. At normal reproduction, the display thumbnail selection section 19 outputs information of all the 64 thumbnail frames to the thumbnail display processing section 22 without performing the thinning-out. As a result, the 64 thumbnail images are arranged in a matrix of 8×8 on the screen. When an instruction of fast-forward reproduction or fast-reverse reproduction, which includes reproduction speed information (search speed information), is input to the system controller 24 by the user, the instruction is given from the system controller 24 to the reproduction processing section 12. The reproduction processing section 12 executes the fast-forward reproduction or fast-reverse reproduction of a moving image at a designated speed. Further, the system controller 24 also transmits the reproduction speed information (search speed information) to the display thumbnail selection section 19. The display thumbnail selection section 19 performs the thinning-out processing of thumbnail frames as follows based on the input reproduction speed information.

The display thumbnail selection section 19 calculates the sums of the degrees of importance of feature frames in a row unit and a column unit, for respective thumbnail frames assigned to the matrix of 8×8. The degrees of importance of feature frames are obtained by the image/sound feature judgment section 16. The display thumbnail selection section 19 judges q rows with the lowest sum of the degrees of importance in a row unit, and simultaneously judges q columns with the lowest sum of the degrees of importance in a column unit. Here, q is a value predetermined in accordance with the reproduction speed (search speed), and becomes larger in proportion to the reproduction speed (search speed). In the example of FIG. 27, q is set to 2. The display thumbnail selection section 19 thins out the q rows and q columns judged in the above from the matrix of 8×8, and supplies the information of the thumbnail frames corresponding to the matrix of 6×6 that remains as a result of the thinning-out to the thumbnail display processing section 22.

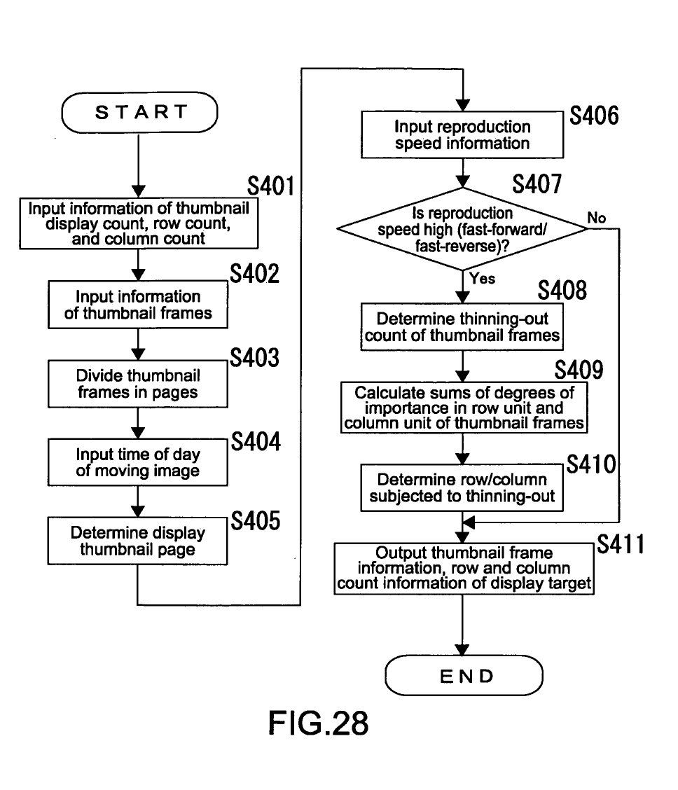

FIG. 28 is a flowchart from the selection of a display thumbnail page by the display thumbnail selection section 19 to the thumbnail thinning-out processing.

The display thumbnail selection section 19 acquires information of the thumbnail display count M, the row count R, the column count C determined by the thumbnail display count determination section 18 (Step S401). Subsequently, the display thumbnail selection section 19 acquires information of each thumbnail frame (time-of-day information) (Step S402), and divides the respective thumbnail frames in pages based on the above-mentioned pieces of information and information of the page count P determined by the thumbnail display count determination section 18 (Step S403).

Next, the display thumbnail selection section 19 acquires information of a time of day of a moving image being reproduced from the system controller 24 (Step S404), and determines a display thumbnail page such that a time of day of the moving image being reproduced is in a time-of-day range of the thumbnail page (Step S405).

Next, the display thumbnail selection section 19 acquires the reproduction speed information (search speed information) of the moving image designated by the user (Step S406). In a case where the reproduction speed thereof is a normal reproduction speed (1× speed) (NO in Step S407), the display thumbnail selection section 19 outputs information of thumbnail frames belonging to the determined display thumbnail page and information of a row count and a column count to the thumbnail display processing section 22 (Step S411). After that, the display thumbnail selection section 19 also monitors a time of day of the moving image being reproduced and repeats the determination of a display thumbnail page and the output of the information of thumbnail frames belonging to a determined display thumbnail page and the information of a row count and a column count to the thumbnail display processing section 22.

Further, in a case where the reproduction speed of a moving image designated by the user is high (fast-forward/fast-reverse reproduction) (YES in Step S407), the display thumbnail selection section 19 executes the thinning-out processing of thumbnails as follows. First, the display thumbnail selection section 19 determines a thinning-out count of thumbnails (value q) according to the predetermined rules, based on the reproduction speed of the moving image designated by the user (Step S408). Subsequently, the display thumbnail selection section 19 calculates the sums of the degrees of importance of feature frames in a row unit and a column unit, the degrees of importance of feature frames being obtained by the image/sound feature judgment section 16, for respective thumbnail frames belonging to a display thumbnail page (Step S409).

Next, the display thumbnail selection section 19 judges q rows with the lowest sum of the degrees of importance in a row unit and q columns with the lowest sum of the degrees of importance in a column unit to be row and columns of the thinning-out targets, respectively (Step S410). Then, the display thumbnail selection section 19 outputs the information of thumbnail frames as display targets in which thumbnail frames corresponding to a row and column as thinning-out targets are eliminated from the thumbnail frames belonging to the display thumbnail page determined in Step S405, the information of a row count obtained by subtracting the value q from the initial row count, and the information of a column count obtained by subtracting the value q from the initial column count, to the thumbnail display processing section 22 (Step S411).

As described above, by the thinning-out of thumbnail frames performed in accordance with the reproduction speed of a moving image, the accuracy in a scene search desired by the user can be reflected on both the reproduction speed of a moving image and a display count of thumbnail images on one screen. Further, by the thinning-out of thumbnail frame in a row unit and column unit, a large fluctuation of a positional relationship between thumbnail images in a matrix can be avoided before and after the change of the reproduction speed. Accordingly, this allows the user to easily find the same thumbnail image under situations in which the reproduction speed (search speed) of a moving image differs, with the result that the operability can be improved.

In addition, the present invention is not limited to the above embodiment and modified examples, and can be variously modified without departing from the gist of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a selection section configured to select a plurality of frames of thumbnail targets, as thumbnail frames, from a moving image including a plurality of frames continuous in terms of time;
a division section configured to divide the selected thumbnail frames in units of pages each including a plurality of thumbnail frames continuous in terms of time;
a reproduction speed input section configured to receive a designation of a reproduction speed of the moving image;
a reproduction processing section configured to reproduce the moving image at the designated reproduction speed; and
a thumbnail display processing section configured to display a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and display one or more of the thumbnail images that include at least the latest thumbnail image and are continuous in a time sequence, as moving-image-synchronized thumbnail images, in a form distinguishable from a different thumbnail image being displayed.

2. The information processing apparatus according to claim 1, wherein
when one of the plurality of thumbnail images displayed in the matrix arrangement is selected by a user, the reproduction processing section causes the time of day of the moving image being reproduced to jump to a time of day of a thumbnail frame corresponding to the selected thumbnail image.

3. The information processing apparatus according to claim 2, further comprising an importance degree calculation section configured to calculate a degree of importance for each thumbnail frame, wherein
the thumbnail display processing section reflects the calculated degree of importance for each thumbnail frame on a display form of the thumbnail images.

4. The information processing apparatus according to claim 3, wherein
the reproduction processing section controls a reproduction speed of the moving image based on the reproduction speed of the moving image that is received by the reproduction speed input section so that thumbnail images imparted with a display form distinguishable as the moving-image-synchronized thumbnail images are switched at a constant speed.

5. The information processing apparatus according to claim 1, wherein
the thumbnail display processing section changes the number of thumbnail images imparted with a display form distinguishable as the moving-image-synchronized thumbnail images, in accordance with the reproduction speed of the moving image that is received by the reproduction speed input section.

6. The information processing apparatus according to claim 1, wherein
the thumbnail display processing section thins out the thumbnail frames divided in units of pages, in accordance with the reproduction speed of the moving image that is received by the reproduction speed input section.

7. The information processing apparatus according to claim 6, wherein
the thumbnail display processing section preferentially thins out an arrangement having a smaller sum of the degrees of importance of the thumbnail frames in at least one of an arrangement in units of rows of the matrix and an arrangement in units of columns of the matrix.

8. An information processing method, comprising:
selecting, by a selection section, a plurality of frames of thumbnail targets, as thumbnail frames, from a moving image including a plurality of frames continuous in terms of time;
dividing, by a division section, the selected thumbnail frames in units of pages each including a plurality of thumbnail frames continuous in terms of time;
receiving, by a reproduction speed input section, a designation of a reproduction speed of the moving image;
reproducing, by a reproduction processing section, the moving image at the designated reproduction speed; and
displaying, by a thumbnail display processing section, a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and displaying one or more of the thumbnail images that include at least the latest thumbnail image and are continuous in a time sequence, as moving-image-synchronized thumbnail images, in a form distinguishable from a different thumbnail image being displayed.

9. A program causing a computer to function as:
a selection section configured to select a plurality of frames of thumbnail targets, as thumbnail frames, from a moving image including a plurality of frames continuous in terms of time;
a division section configured to divide the selected thumbnail frames in units of pages each including a plurality of thumbnail frames continuous in terms of time;
a reproduction speed input section configured to receive a designation of a reproduction speed of the moving image;
a reproduction processing section configured to reproduce the moving image at the designated reproduction speed; and
a thumbnail display processing section configured to display a plurality of thumbnail images in the units of pages including a latest thumbnail image in a matrix arrangement with a thumbnail image corresponding to a thumbnail frame positioned closest to a time of day of the reproduced moving image being set as the latest thumbnail image, and display one or more of the thumbnail images that include at least the latest thumbnail image and are continuous in a time sequence, as moving-image-synchronized thumbnail images, in a form distinguishable from a different thumbnail image being displayed.
